(19) United States
(12) Patent Application Publication
(10) Pub. No.: US 2023/0095333 A1
(43) Pub. Date: Mar. 30, 2023

(54) CATIONIC LATEX EMULSION INCLUDING DIQUATERNARY AMMONIUM SURFACTANT

(71) Applicant: CARGILL, INCORPORATED, Wayzata, MN (US)

(72) Inventors: Sung AHN, St Paul, MN (US); Todd L. KURTH, Maple Grove, MN (US); Hassan Ali TABATABAEE, Plymouth, MN (US)

(73) Assignee: CARGILL, INCORPORATED, Wayzata, MN (US)

(21) Appl. No.: 17/758,891

(22) PCT Filed: Feb. 3, 2021
(86) PCT No.: PCT/US2021/016380

§ 371 Date: Jul. 15, 2022

Related U.S. Application Data
(60) Provisional application No. 62/969,869, filed on Feb. 4, 2020.

(51) Int. Cl. C08L 9/08; C08F 2/28; C08L 95/00

(52) U.S. Cl. CPC C08L 9/08; C08F 2/28; C08L 95/005

(57) ABSTRACT

Various aspects of the present invention relate to cationic latex emulsions, methods of making the same, various materials including the cationic latex emulsion such as asphalt emulsions, and methods of making the asphalt emulsions. A cationic latex emulsion includes latex particles. The cationic latex emulsion includes an aqueous liquid emulsified with the latex particles. The cationic latex emulsion also includes a cationic surfactant that is a diquaternary ammonium surfactant.

### CROSS-REFERENCE TO RELATED APPLICATIONS

This application claims the benefit of U.S. Provisional Patent Application No. 62/969,869, filed Feb. 4, 2020, which is hereby incorporated by reference herein in its entirety.

### BACKGROUND

Latex emulsions include latex polymer particles dispersed in an aqueous liquid. Latex emulsions are useful in many industries to produce a wide variety of products, such as paper coatings, tires, foams, asphalt concrete, carpet back coatings, or inks. Anionic latex emulsions, including anionic polymer particles that stick to cationic surfaces, are transformed to cationic latex emulsions in order to combine them usefully with other materials, such as with cationic asphalt emulsions to form polymer-modified asphalt concrete.

### SUMMARY OF THE INVENTION

Various aspects of the present invention provide a cationic latex emulsion. The cationic latex emulsion includes latex particles. The cationic latex emulsion includes an aqueous liquid emulsified with the latex particles. The cationic latex emulsion includes a cationic surfactant having the structure:

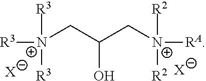

At each occurrence R² is independently chosen from substituted or unsubstituted linear or branched (C₁-C₆)alkyl, substituted or unsubstituted linear or branched (C₁-C₆)alkenyl, substituted or unsubstituted (C₄-C₁₀)cycloalkyl or (C₄-C₁₀)cycloalkenyl, substituted or unsubstituted (C₁-C₁₀)alkoxy (preferably, substituted or unsubstituted (C₁-C₆) alkoxy), including but not limited to (C₁-C₁₀)alkyl alcohol, (C₁-C₁₀)alkyl ether or (C₁-C₁₀)alkoxyalcohol, and substituted or unsubstituted (C₄-C₁₀)aryl, or wherein R² together with another R² forms a substituted or unsubstituted aliphatic or aromatic (C₄-C₁₂)heterocycle together with the nitrogen to which they are attached. At each occurrence R³ is independently chosen from substituted or unsubstituted linear or branched (C₁-C₆)alkyl, substituted or unsubstituted linear or branched (C₁-C₆)alkenyl, substituted or unsubstituted (C₄-C₁₀)cycloalkyl or (C₄-C₁₀)cycloalkenyl, substituted or unsubstituted (C₁-C₁₀)alkoxy (preferably, substituted or unsubstituted (C₁-C₆) alkoxy) including but not limited to (C₁-C₁₀)alkyl alcohol, (C₁-C₁₀)alkyl ether or (C₁-C₁₀)alkoxyalcohol, or and substituted or unsubstituted (C₄-C₁₀)aryl, or wherein R³ together with another R³ forms a substituted or unsubstituted aliphatic or aromatic (C₄-C₁₂)heterocycle together with the nitrogen to which they are attached. At each occurrence X⁻ is independently chosen from an anion. The variable R^{A} is chosen from a substituted or unsubstituted (C₄-C₂₂)alkyl, a substituted or unsubstituted (C₄-C₂₂)alkenyl, and

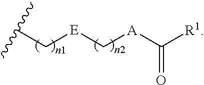

The variable R¹ is chosen from a substituted or unsubstituted (C₄-C₂₂)alkyl and a substituted or unsubstituted (C₄-C₂₂)alkenyl, wherein R¹ is optionally modified, the modification including maleic anhydride modification, polymerization, ene-reaction modified, hydrogenation, isomerization, branching, or a combination thereof. The variable A is —NH— or —O—. The variable E is —CH₂—, —((C₂-C₄)alkoxy)ₙ₃-, or —O—. The variable n1 is an integer that is 0 to 9. The variable n2 is an integer that is 0 to 9. The value n1+n2 is 1 to 10. The variable n3 is an integer that is 1 to 40.

Various aspects of the present invention provide a cationic latex emulsion. The cationic latex emulsion includes latex particles. The cationic latex emulsion includes an aqueous liquid emulsified with the latex particles. The cationic latex emulsion includes a cationic surfactant having the structure:

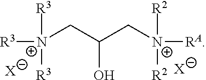

At each occurrence R² is independently chosen from substituted or unsubstituted (C₁-C₆)alkyl or substituted or unsubstituted (C₁-C₆)alkoxy.

At each occurrence R³ is independently chosen from substituted or unsubstituted (C₁-C₆)alkyl or substituted or unsubstituted (C₁-C₆)alkoxy.

At each occurrence X⁻ is independently chosen from an anion. The variable R^{A} is chosen from a substituted or unsubstituted (C₄-C₂₂)alkyl, a substituted or unsubstituted (C₄-C₂₂)alkenyl, and

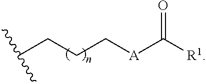

The variable R¹ is chosen from a substituted or unsubstituted (C₄-C₂₂)alkyl and a substituted or unsubstituted (C₄-C₂₂)alkenyl, wherein R¹ is optionally modified, the modification including maleic anhydride modification, polymerization, ene-reaction modified, hydrogenation, isomerization, branching, or a combination thereof. The variable A is —NH— or —O—. The variable n is 1 to 10.

Various aspects of the present invention provide a method of forming the cationic latex emulsion. The method includes combining an anionic latex emulsion with the cationic surfactant. The anionic latex emulsion includes the latex particles. The anionic latex emulsion also includes the aqueous liquid emulsified with the latex particles. The method also includes agitating the combination of the anionic latex emulsion and the cationic surfactant to form the cationic latex emulsion. The method also may include further treating the cationic latex emulsion with acids to modify (i.e. reduce) their viscosity. Suitable acids can be mineral acids, organic acids, or a combination thereof. Typically, the pH is added to reduce the viscosity to the desirable level, while not reducing the pH below about 5.5, for example not below a pH of 5, 4, 3.5, or not below a pH of 3.

Various aspects of the present invention provide an asphalt emulsion including the cationic latex emulsion. Various aspects of the present invention provide an asphalt emulsion including the cationic latex emulsion and cationic bitumen particles.

Various aspects of the present invention provide a method of forming the asphalt emulsion. The method includes combining a cationic asphalt emulsion with the cationic latex emulsion, to form the asphalt emulsion.

Various aspects of the present invention provide a method of coating a carpet to form a carpet back coating. The method includes coating the carpet with the cationic latex emulsion to form the carpet back coating thereon.

Various aspects of the present invention provide a paper coating, tires, asphalt concrete, carpet back coating, latex paint, foam, or ink including the cationic latex emulsion.

In various aspects, the cationic surfactant of the present invention, latex emulsions formed therewith, and methods of forming and using the same can have certain advantages over other surfactants or emulsions, at least some of which are unexpected. For example, in various aspects, the cationic surfactant of the present invention provides a good electrostatic stabilizing property during a conversion process from anionic latex to cationic latex as it goes through the iso-electric state/zero charge state. In various aspects, the cationic surfactant of the present invention can offer greater versatility than the traditional fatty aminopropylamine-based quaternary ammonium chemistry as it provides electrostatic stabilization functionality while offering steric stabilization functionality in a conversion process from an anionic latex to cationic latex with the ability to tune both the polar and fatty profile of the cationic surfactant without means to incorporating of a co-surfactant or second additive nonionic or cationic stabilizers. In various aspects, the steric stabilizing effect can be observed with a significant viscosity build-up of the latex depending on the polar group and the fatty chain of the cationic surfactant. The cationic surfactant bears a polar head group that can generate an electric double layer and a lypophilic side chain able to provide steric repulsion. The steric stabilization mechanism can provides a physical barrier to agglomeration of particles by adsorption on surface of the latex colloids.

For example, in various aspects, the fatty acid source used to form the emulsifier can be a flexible source, such as a bio-based fatty acid source or a petroleum-based source. In various aspects, the amine source used to form the cationic surfactant can be a flexible source, such as a bio-based or a petroleum-based source. The starting materials used to form the cationic surfactant can be selected to tune the properties of the cationic surfactant as desired, offering a great deal of performance and production flexibility. For example, the lypophilic and/or hydrophilic component of the cationic surfactant can be adjusted via variation of starting materials to tune the properties of the cationic surfactant as desired. In various aspects, the hydroxy functionality and ability to use amidoamines or fatty amines with various tertiary amines, for example trialkylamines, provide flexibility of production and performance of the cationic surfactant not possible with incumbent products. In various aspects, the emulsifier of the present invention can be derived from bio-based renewable starting materials and can provide similar or better emulsification properties for latex or oil-in-water emulsions than surfactants that are petroleum or non-renewably derived.

Traditional fatty aminopropylamine-based quaternary ammonium surfactants are limited by the complex hydrogenation, quaternization process, and unfavorable reaction conditions that require the use of high pressure, high reaction temperature, and alkaline conditions that lead to unavoidable decomposition by-products which can cause significant odor and hazard. The decomposition by-products can also lead to performance variability of the resulting surfactant, with less ability to precisely tune the polarity of lipophilic and hydrophilic portions of the surfactant. In various aspects, the cationic surfactant of the present invention made with amidoamines and fatty amines provide favorable reaction conditions, less or no production of decomposition byproducts, and greater flexibility of production and performance, as the composition can be controlled and tuned to application needs (e.g., by adjusting the hydrophilic and lipophilic portions of the surfactant). In various aspects, the cationic surfactant of the present invention can be made at low temperature conditions and atmospheric pressure.

### BRIEF DESCRIPTION OF THE DRAWINGS

The accompanying drawings, which are incorporated in and constitute a part of this application, illustrate several aspects of the invention and together with a description of the embodiments serve to explain the principles of the invention. A brief description of the drawings is as follows:

FIG. 1 is a graphical representation showing viscosity change of cationic latex via tuning of the fatty profile of the amidoamine-based surfactant consisting of different surfactant levels of Example 1 and 2 by weight ratio.

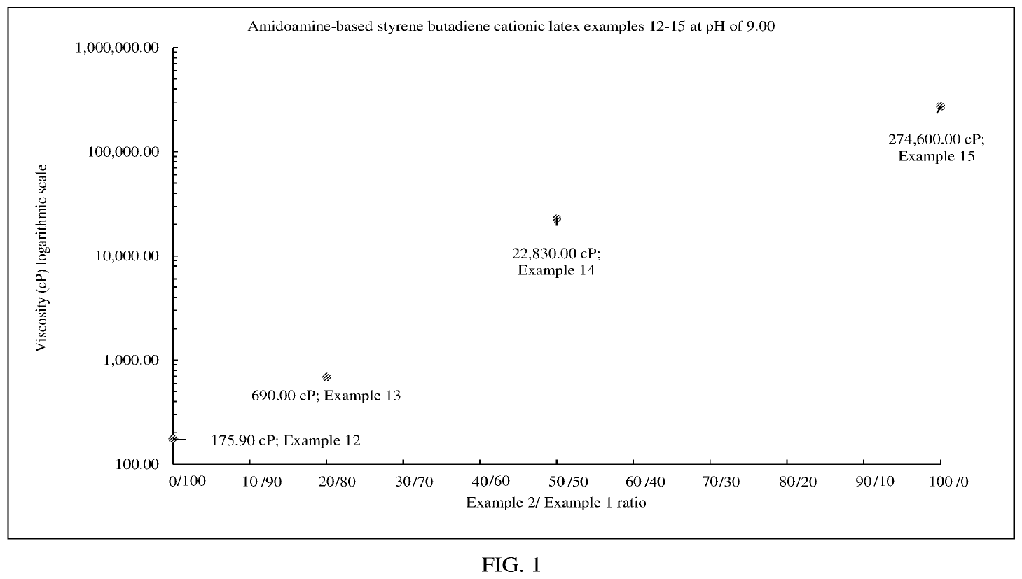

FIG. 2 is a graphical representation showing viscosity change of cationic latex at pH of 5.30 via tuning of the fatty profile of the amidoamine-based surfactant consisting of different surfactant levels of Example 1 and 2 by weight ratio.

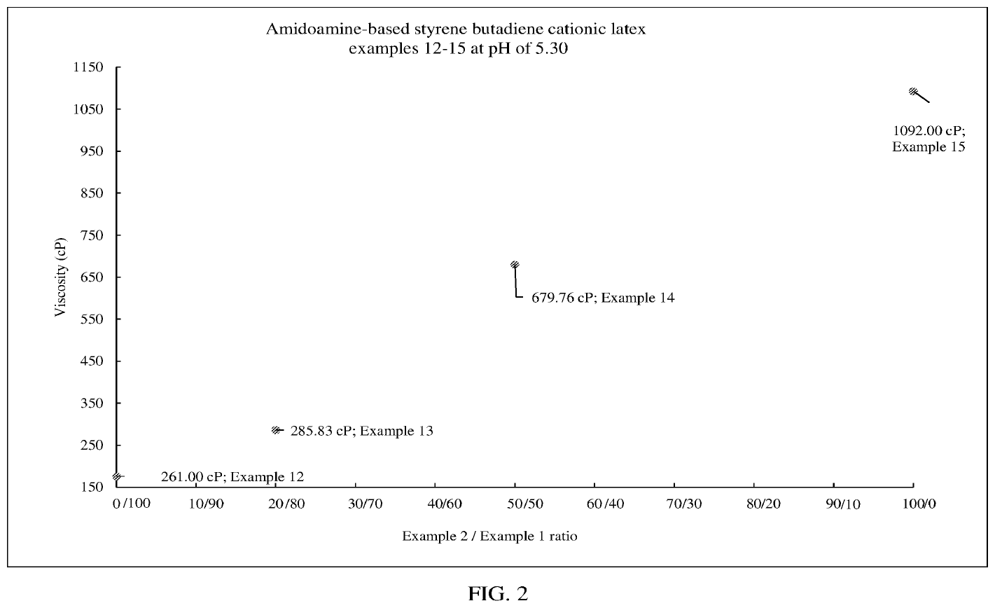

FIG. 3 is graphical representation showing viscosity change of cationic latex example 29 from a pH of 9.00 to 3.00.

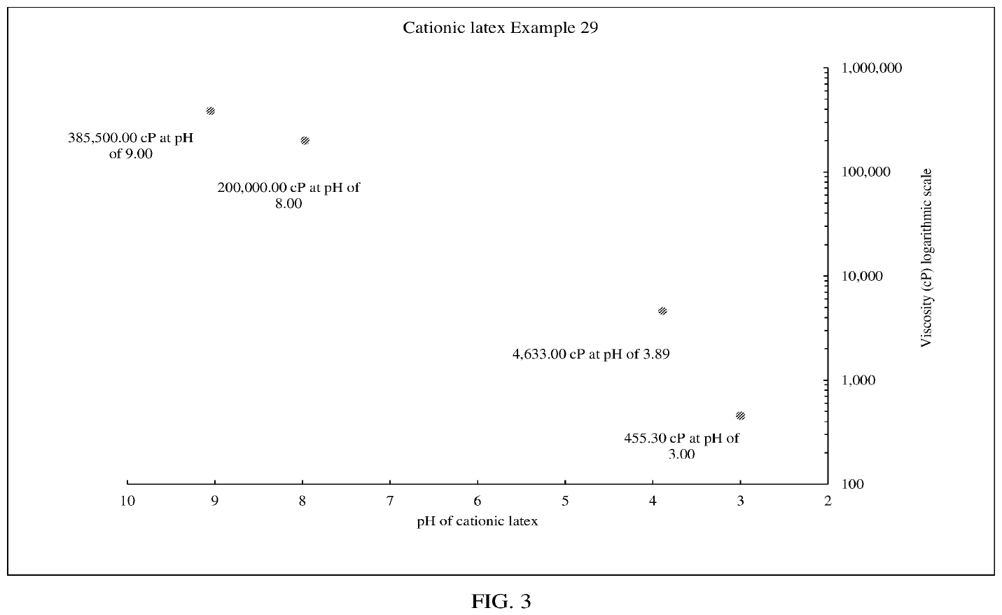

FIG. 4 is a graphical representation showing viscosity change of cationic latex via tuning of the polar profile of the amidoamine-based surfactant at different surfactant levels of Examples 1 and 5.

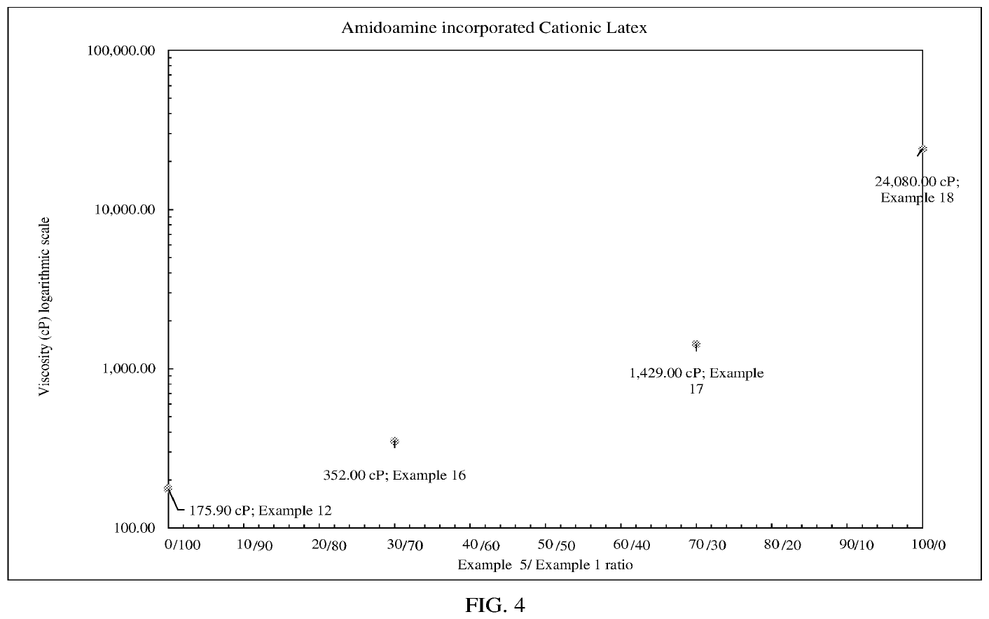

### DETAILED DESCRIPTION OF THE INVENTION

Reference will now be made in detail to certain embodiments of the disclosed subject matter. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the invention, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material, such that about 0 wt % to about 5 wt % of the composition is the material, or about 0 wt % to about 1 wt %, or about 5 wt % or less, or less than, equal to, or greater than about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

The term “substituted” as used herein in conjunction with a molecule or an organic group as defined herein refers to the state in which one or more hydrogen atoms contained therein are replaced by one or more non-hydrogen atoms. The term “functional group” or “substituent” as used herein refers to a group that can be or is substituted onto a molecule or onto an organic group. Examples of substituents or functional groups include, but are not limited to, a halogen (e.g., F, Cl, Br, and I); an oxygen atom in groups such as hydroxy groups, alkoxy groups, aryloxy groups, aralkyloxy groups, oxo(carbonyl) groups, carboxyl groups including carboxylic acids, carboxylates, and carboxylate esters; a sulfur atom in groups such as thiol groups, alkyl and aryl sulfide groups, sulfoxide groups, sulfone groups, sulfonyl groups, and sulfonamide groups; a nitrogen atom in groups such as amines, hydroxyamines, nitriles, nitro groups, N-oxides, hydrazides, azides, and enamines; and other heteroatoms in various other groups. Non-limiting examples of substituents that can be bonded to a substituted carbon (or other) atom include F, Cl, Br, I, OR, OC(O)N(R)₂, CN, NO, NO₂, ONO₂, azido, CF₃, OCF₃, R, O (oxo), S (thiono), C(O), S(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, and C(═NOR)R, wherein R can be hydrogen or a carbon-based moiety; for example, R can be hydrogen, (C₁-C₁₀₀)hydrocarbyl, alkyl, acyl, cycloalkyl, aryl, aralkyl, heterocyclyl, heteroaryl, or heteroarylalkyl; or wherein two R groups bonded to a nitrogen atom or to adjacent nitrogen atoms can together with the nitrogen atom or atoms form a heterocyclyl.

The term “alkyl” as used herein refers to straight chain and branched alkyl groups and cycloalkyl groups having from 1 to 40 carbon atoms, 1 to about 20 carbon atoms, 1 to 12 carbons or, in some embodiments, from 1 to 8 carbon atoms. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, t-butyl, neopentyl, isopentyl, and 2,2-dimethylpropyl groups. As used herein, the term “alkyl” encompasses n-alkyl, isoalkyl, and anteisoalkyl groups as well as other branched chain forms of alkyl. Representative substituted alkyl groups can be substituted one or more times with any of the groups listed herein, for example, amino, hydroxy, cyano, carboxy, nitro, thio, alkoxy, and halogen groups.

The term “alkenyl” as used herein refers to straight and branched chain and cyclic alkyl groups as defined herein, except that at least one double bond exists between two carbon atoms. Thus, alkenyl groups have from 2 to 40 carbon atoms, or 2 to about 20 carbon atoms, or 2 to 12 carbon atoms or, in some embodiments, from 2 to 8 carbon atoms. Examples include, but are not limited to vinyl, —CH═CH(CH₃), —CH═C(CH₃)₂, —C(CH₃)═CH₂, —C(CH₃)═CH(CH₃), —C(CH₂CH₃)═CH₂, cyclohexenyl, cyclopentenyl, cyclohexadienyl, butadienyl, pentadienyl, and hexadienyl among others.

The term “cycloalkyl” as used herein refers to cyclic alkyl groups such as, but not limited to, cyclopropyl, cyclobutyl, cyclopentyl, cyclohexyl, cycloheptyl, and cyclooctyl groups. In some embodiments, the cycloalkyl group can have 3 to about 8-12 ring members, whereas in other embodiments the number of ring carbon atoms range from 3 to 4, 5, 6, or 7. Cycloalkyl groups further include polycyclic cycloalkyl groups such as, but not limited to, norbornyl, adamantyl, bornyl, camphenyl, isocamphenyl, and carenyl groups, and fused rings such as, but not limited to, decalinyl, and the like. Cycloalkyl groups also include rings that are substituted with straight or branched chain alkyl groups as defined herein. Representative substituted cycloalkyl groups can be mono-substituted or substituted more than once, such as, but not limited to, 2,2-, 2,3-, 2,4-2,5- or 2,6-disubstituted cyclohexyl groups or mono-, di- or tri-substituted norbornyl or cycloheptyl groups, which can be substituted with, for example, amino, hydroxy, cyano, carboxy, nitro, thio, alkoxy, and halogen groups. The term “cycloalkenyl” alone or in combination denotes a cyclic alkenyl group.

The term “aryl” as used herein refers to cyclic aromatic hydrocarbon groups that do not contain heteroatoms in the ring. Aryl groups include, but are not limited to, phenyl, azulenyl, heptalenyl, biphenyl, indacenyl, fluorenyl, phenanthrenyl, triphenylenyl, pyrenyl, naphthacenyl, chrysenyl, biphenylenyl, anthracenyl, and naphthyl groups. In some embodiments, aryl groups contain about 6 to about 14 carbons in the ring portions of the groups. Aryl groups can be unsubstituted or substituted, as defined herein. Representative substituted aryl groups can be mono-substituted or substituted more than once, such as, but not limited to, a phenyl group substituted at any one or more of 2-, 3-, 4-, 5-, or 6-positions of the phenyl ring, or a naphthyl group substituted at any one or more of 2- to 8-positions thereof.

As used herein, the term “polymer” refers to a molecule having at least one repeating unit and can include copolymers.

### Cationic Latex Emulsion.

Various aspects of the present invention provide a cationic latex emulsion. The cationic latex emulsion includes latex particles, and an aqueous liquid emulsified with the latex particles. The cationic latex emulsion also includes a cationic surfactant having the structure:

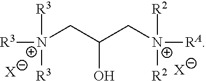

At each occurrence R² can be independently chosen from substituted or unsubstituted linear or branched (C₁-C₆)alkyl, substituted or unsubstituted linear or branched (C₁-C₆)alkenyl, substituted or unsubstituted (C₄-C₁₀)cycloalkyl or (C₄-C₁₀)cycloalkenyl, substituted or unsubstituted (C₁-C₁₀)alkoxy (preferably, substituted or unsubstituted (C₁-C₆) alkoxy), including but not limited to (C₁-C₁₀)alkyl alcohol, (C₁-C₁₀)alkyl ether or (C₁-C₁₀)alkoxyalcohol, and substituted or unsubstituted (C₄-C₁₀)aryl, or wherein R² together with another R² forms a substituted or unsubstituted aliphatic or aromatic (C₄-C₁₂)heterocycle together with the nitrogen to which they are attached. At each occurrence R² can be independently chosen from substituted or unsubstituted (C₁-C₆)alkyl or (C₁-C₆)alkyl alcohol (e.g., ethanol). At each occurrence R² can be independently chosen from methyl and ethyl. At each occurrence R² can be methyl.

At each occurrence R³ can be independently chosen from substituted or unsubstituted linear or branched (C₁-C₆)alkyl, substituted or unsubstituted linear or branched (C₁-C₆)alkenyl, substituted or unsubstituted (C₄-C₁₀)cycloalkyl or (C₄-C₁₀)cycloalkenyl, substituted or unsubstituted (C₁-C₁₀)alkoxy (preferably, substituted or unsubstituted (C₁-C₆) alkoxy), including but not limited to (C₁-C₁₀)alkyl alcohol, (C₁-C₁₀)alkyl ether or (C₁-C₁₀)alkoxyalcohol, substituted or unsubstituted (C₁-C₁₀)alkyl ether, and substituted or unsubstituted (C₄-C₁₀)aryl, or wherein R³ together with another R³ forms a substituted or unsubstituted aliphatic or aromatic (C₄-C₁₂)heterocycle together with the nitrogen to which they are attached. At each occurrence R³ can be independently chosen from substituted or unsubstituted (C₁-C₆)alkyl or (C₁-C₆)alkyl alcohol (e.g., ethanol). At each occurrence R³ can be independently chosen from methyl and ethyl. In some aspects, R³ is ethanol. In some aspects, R³ can be methyl.

At each occurrence X⁻ can be independently chosen from an anion. The variable X⁻ can be an organic anion. The variable X⁻ can be an inorganic anion. At each occurrence X⁻ can be independently chosen from a (C₁-C₁₀)carboxylic acid conjugate base, acetate, sulfate, Cl⁻, Br⁻, I⁻, and NO₃⁻. The (C₁-C₁₀)carboxylic acid conjugate base can be a (C₁-C₄)carboxylic acid conjugate base such as formate or acetate. The (C₁-C₁₀)carboxylic acid conjugate base can be a (C₂-C₄)carboxylic acid conjugate base.

The variable R^{A} can be chosen from a substituted or unsubstituted (C₄-C₂₂)alkyl, a substituted or unsubstituted (C₄-C₂₂)alkenyl, and

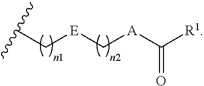

The variable R^{A} can be chosen from a substituted or unsubstituted (C₄-C₂₂)alkyl, a substituted or unsubstituted (C₄-C₂₂)alkenyl, and

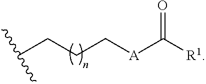

The variable R^{A} can be independently chosen from a substituted or unsubstituted (C₄-C₂₂)alkyl and a substituted or unsubstituted (C₄-C₂₂)alkenyl. The variable R^{A} can be (C₁₀-C₂₀)alkyl, (C₁₀-C₁₄)alkyl, or C₁₂alkyl. The variable R^{A} can be

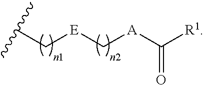

the variable R^{A} can be

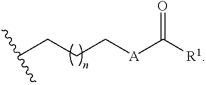

The variable R¹ can be chosen from a substituted or unsubstituted (C₄-C₂₂)alkyl and a substituted or unsubstituted (C₄-C₂₂)alkenyl, wherein R¹ is optionally modified, the modification including maleic anhydride modification, polymerization, ene-reaction modified, hydrogenation, isomerization, branching, or a combination thereof. The variable R¹ can be (C₁₀-C₂₀)alkyl. The variable R¹ can be (C₁₀-C₁₄)alkyl. The variable R¹ can be C₁₂alkyl. The variable R¹ can be derived from a bio-based fatty acid source. The variable R¹ can be derived from a petrochemical fatty acid source. The variable R¹ can be unmodified. The variable R¹ can be modified, the modification including maleic anhydride modification, ene-reaction modified, hydrogenation, isomerization, polymerization, branching, or a combination thereof.

The variable A can be —NH— or —O—. The variable A can be —NH—. The variable A can be —O—. The variable E can be —CH₂—, —((C₂-C₄)alkoxy)ₙ₃-, or —O—. The variable E can be —CH₂—. The variable n3 can be an integer that is 1 to 40, 1 to 20, 1 to 10, 1 to 7, or 1 or more, or less than, equal to, or greater than 2, 3, 4, 5, 6, 7, 8, 9, 10, 12, 14, 16, 18, 20, 25, 30, 35, or 40 or less.

The variable n1 can be an integer that is 0 to 9, 0 to 6, 0 to 3, or 0, or 1 or more, or less than, equal to, or greater than 2, 3, 4, 5, 6, 7, 8, or 9 or less. The variable n2 can be an integer that is 0 to 9, 0 to 6, 0 to 3, or 0, or 1 or more, or less than, equal to, or greater than 2, 3, 4, 5, 6, 7, 8, or 9 or less. The value n1+n2 can be 1 to 10, or 1 to 6, or 1 to 3, or 1 or more, or less than, equal to, or greater than 2, 3, 4, 5, 6, 7, 8, 9, or 10 or less.

The cationic latex can have the structure:

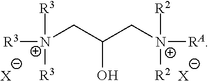

At each occurrence R² can be independently chosen from substituted or unsubstituted (C₁-C₆)alkyl. At each occurrence R³ can be independently chosen from substituted or unsubstituted (C₁-C₆)alkyl or (C₁-C₆)alkyl alcohol. At each occurrence X⁻ can be independently chosen from an anion. The variable R^{A} can be chosen from a substituted or unsubstituted (C₄-C₂₂)alkyl, a substituted or unsubstituted (C₄-C₂₂)alkenyl, and

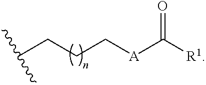

The variable R¹ can be chosen from a substituted or unsubstituted (C₄-C₂₂)alkyl and a substituted or unsubstituted (C₄-C₂₂)alkenyl, wherein R¹ is optionally modified, the modification including maleic anhydride modification, polymerization, ene-reaction modified, hydrogenation, isomerization, branching, or a combination thereof. The variable A can be —NH— or —O—. The variable n can be 1 to 10, or 1 to 6, or 1 to 3, or 1 or more, or less than, equal to, or greater than 2, 3, 4, 5, 6, 7, 8, 9, or 10 or less.

The R¹ group of the cationic surfactant can be derived from any suitable fatty acid source, such as one or more fatty acids or triglycerides. The variable R¹ can be derived from a petrochemical fatty acid source, R¹ can be derived from a bio-based fatty acid source, can be ester, such as biodiesel, or a combination thereof. The bio-based fatty acid source can be free fatty acids, a plant-based oil, animal-based oil (e.g., lard, tallow), deodorizer distillate, recovered corn oil (e.g., residual liquids resulting from the manufacturing process of turning corn into ethanol, also known as “corn stillage oil”) or derivatives thereof (e.g., polymerized corn oil streams), refined bleached deodorized soy bean oil, an ultrafiltered oil or a combination thereof. Deodorizer distillate is a product from physical or enzymatic refining of vegetable oils, and it is generally fatty acid but also contains ester and many minor impurities found in the various vegetable streams. Examples of plant-based oils can include soybean oil, linseed oil, canola oil, rapeseed oil, castor oil, tall oil, cottonseed oil, sunflower oil, palm oil, peanut oil, safflower oil, corn oil, corn stillage oil, lecithin (phospholipids) and combinations and crude streams thereof. In some embodiments, the bio-based fatty acid source is soy oil, canola oil, sunflower oil, or a combination thereof.

The fatty acid source from which R¹ is derived can be modified or unmodified. Modification can include functionalization with one or more heteroatoms (e.g., substitution on R¹ with O, N, S, P, or a combination thereof, alone or as part of another functional group). Modification can include isomerization, hydrogenation, fractionation, branching, epoxidation, vulcanization, polymerization, maleic anhydride modification, acrylic acid modification, dicyclopentadiene modification, conjugation via reaction with iodine, interesterification, processing to modify acid value, processing to modify hydroxyl number, or a combination thereof.

Waste oil streams can be efficient and useful fatty acid sources. For example, distillate streams, vegetable oils, and recovered corn oil streams, can be cost-effective fatty acids sources as well as fatty acids derived from waste streams containing phosphatides and other impurities (e.g., sterols, tocopherols, starches, waxes, etc.). However, fatty acids in their natural or synthetic form may also be utilized herein as the fatty acid source. The fatty acid source may also be derived from a combination of various waste streams, a combination of various natural or synthetic oils, or a combination of both waste streams and natural/synthetic oil.

The cationic surfactant can have the structure:

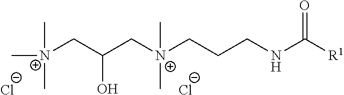

The cationic surfactant can have the structure:

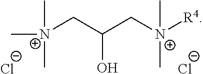

The variable R⁴ can be chosen from a substituted or unsubstituted (C₄-C₂₂)alkyl and a substituted or unsubstituted (C₄-C₂₂)alkenyl, wherein R⁴ is optionally modified, the modification comprising maleic anhydride modification, polymerization, ene-reaction modified, hydrogenation, isomerization, branching, or a combination thereof.

The cationic latex emulsion can include any suitable amount of the cationic surfactant. For example, the cationic latex emulsion can include 0.1 wt % to 20 wt % of the cationic surfactant by weight of the latex particles, or 0.5 wt % to 10 wt %, or 1 wt % to 5 wt %, or 1.5 wt % to 4 wt %, or 0.1 wt % or more, or less than, equal to, or greater than 0.2 wt %, 0.4, 0.5, 0.6, 0.8, 1, 1.5, 2, 2.5, 3, 3.5, 4, 4.5, 5, 6, 7, 8, 9, 10, 12, 14, 16, 18 wt %, or 20 wt % or less of the cationic surfactant by weight of the latex particles.

The cationic latex emulsion can include any suitable amount of the latex particles. For example, the latex particles can be 40 wt % to 80 wt % of the cationic latex emulsion, or 60 wt % to 70 wt %, or 40 wt % or more, or less than, equal to, or greater than 45 wt %, 50, 55, 60, 65, 70, 75 wt %, or 80 wt % or less of the cationic latex emulsion.

The cationic latex emulsion can include any suitable amount of the aqueous liquid. For example, the aqueous liquid can be 20 wt % to 60 wt % of the cationic latex emulsion, or 30 wt % to 40 wt %, or 20 wt % or more, or less than, equal to, or greater than 25 wt %, 30, 35, 40, 45, 50, 55 wt %, or 60 wt % or more of the cationic latex emulsion.

The cationic latex emulsion can have any suitable viscosity as determined by ASTM method D 2196. For example, at room temperature (e.g., 25° C.), the cationic latex emulsion can have a viscosity at 25° C. (according to ASTM method D 2196 (e.g., dynamic viscosity)) of 1,000 cP to 500,000 cP, or 1,000 cP to 100,000 cP, or 1,000 cP or more, or less than, equal to, or greater than 2,000 cP, 5,000, 10,000, 20,000, 30,000, 40,000, 50,000, 60,000, 70,000, 80,000, 90,000, 100,000, 150,000, 200,000, 250,000, 300,000, 400,000 cP, or 500,000 cP or less.

Passing the cationic latex emulsion through a mesh can result in minimal cationic latex residue remaining on the mesh. For example, passing the cationic latex emulsion through a 300 micron diameter mesh can result in less than 1 wt % of the cationic latex emulsion remaining on the mesh, or less than 0.8 wt %, 0.6, 0.5, 0.4, 0.3, 0.2, 0.1, 0.05, or less than 0.01 wt % of the cationic latex emulsion remaining on the mesh.

The cationic latex emulsion can include one or more acids, or the cationic latex emulsion can be substantially free of one or more acids. The one or more acids can be any suitable acids, such as mineral acids, organic acids, or a combination thereof. The one or more acids can be sulfuric acid, acetic acid, hydrochloric acid, boric acid, phosphoric acid, or a combination thereof.

### Method of Forming the Latex Emulsion.

Various aspects of the present invention provide a method of forming the cationic latex emulsion of the present invention. The method can be any suitable method that results in the cationic latex emulsion. The method can include combining an anionic latex emulsion with the cationic surfactant. The anionic latex emulsion can include the latex particles and the aqueous liquid emulsified with the latex particles. The method can include agitating the combination of the anionic latex emulsion and the cationic surfactant to form the cationic latex emulsion. The method also includes further treating the cationic latex emulsion with acids. Suitable acids can be mineral acids, organic acids, or a combination thereof.

The agitating can be any suitable agitating that generated the cationic latex emulsion. For example, the agitating can include agitating the combination of the anionic latex emulsion and the cationic surfactant to increase the viscosity thereof. The agitating can include agitating the combination of the anionic latex emulsion and the cationic surfactant to increase the viscosity thereof until said viscosity becomes stable. For example, the solution can be agitated at a sufficient viscosity for a sufficient time to stabilize the viscosity thereof, such as at 50-500 rpm for 0.5 to 10 minutes or about 1 minute. Steric stabilization can be indicated by the viscosity build-up of the latex emulsion. Viscosity of the cationic latex can be tuned to a desired range of viscosity depending on the length of the amine starting material denoted by (“n” or “n1” and “n2”), depending on the R³ group (e.g. the alkyl alcohol polar functionalities) of the amine starting material (NR³)₃, and the fatty groups (e.g., R¹, R⁴, and/or R^{A}) of the cationic surfactant. Viscosity of the cationic latex can be further adjusted by adding acids. Suitable acids can be mineral acids, organic acids, or a combination thereof.

The cationic surfactant can be combined with the anionic latex emulsion as a solution of the cationic surfactant in a solvent. The solvent can be any one or more suitable solvents. The solvent can include an alcohol, a diol, water, or a combination thereof. The solvent can include a (C₁-C₅)alkyl alcohol, a di(C₁-C₅)alkylene glycol, or a combination thereof. The solvent can include ethanol, methanol, diethylene glycol, dipropylene glycol, isopropyl alcohol, water, or a combination thereof. The solvent can include water. The solvent can include a mixture of water with at least one chosen from ethanol, diethylene glycol, and a combination there.

The cationic surfactant can be any suitable proportion of the solution of the cationic surfactant in the solvent. For example, the cationic surfactant can be about 20 wt % to 80 wt % of the solution of the cationic surfactant in the solvent, or about 45 wt % to 60 wt %, or 20 wt % or more, or less than, equal to, or greater than 25 wt %, 30, 35, 40, 45, 50, 55, 60, 65, 70, 75 wt %, or 80 wt % or less.

In various aspects, the cationic latex emulsion can be prepared by charge inversion of a wide range of anionic latex such as styrene-acrylic copolymer latex, acrylic polymer, and styrene-butadiene copolymer latex with different residue of content from 50% to 70%. Anionic latex can include UP70, UP72, UP74, UP76, and UP7289 from UltraPave Corp. Butonal NS-175, Butanol NX-1129, and from BASF corp. Denka™ Neoprene liquid dispersions including Denka™ 571, Denka™ 671A, Denka™ 750, and Denka™ 842A from Denka corp. UCAR™ Latex series including but not limited to DL 420 G Acrylic Emulsion Polymer, UCAR™ LATEX 2012 Emulsion, UCAR™ Latex 481, and UCAR™ Latex 651 from Dow Chemical. Anionic latex can also include general retail store available liquid rubber products that are used as mortar additives and for water-proofing applications.

In some aspects, the present invention provides a method of forming the cationic surfactant. In some aspects, the method of forming the cationic latex emulsion of the present invention can include forming the cationic surfactant. Forming the cationic surfactant can include reacting HOC(O)—R¹ with a compound having the structure

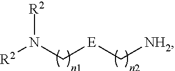

to provide a terminal amine having the structure

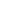

The method can include acidifying the terminal amine to provide an ammonium salt. The method can include treating the ammonium salt with an epihalohydrin to provide a gamma hydroxy haloammonium salt. The method can also include treating the gamma haloammonium salt with (R³)₃N, as described below, to provide the cationic surfactant.

The method of forming the cationic surfactant can include reacting HOC(O)—R¹ with a compound having the structure

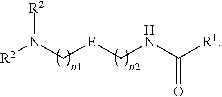

to provide a terminal amine having the structure

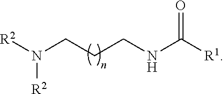

The method can include acidifying the terminal amine to provide an ammonium salt. The method can include treating the ammonium salt with an epihalohydrin to provide a gamma haloammonium salt. The method can also include treating the gamma haloammonium salt with (R³)₃N, to provide the cationic surfactant. The material (R³)₃N can be any material consistent with the structures described herein for R³. For example, (R³)₃N can be trimethylamine, triethylamine, triethanolamine, or methyldiethanolamine.

The method can include acidifying the terminal amine to provide an ammonium salt having the structure

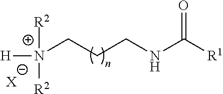

The method can include treating the ammonium salt with an epihalohydrin to provide a gamma hydroxy haloammonium salt having the structure

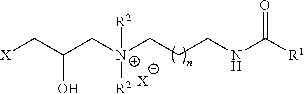

The method of forming the cationic surfactant can include reacting the gamma hydroxy haloammonium salt with a (R³)₃N compound having the structure

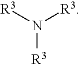

to provide a final cationic surfactant structure

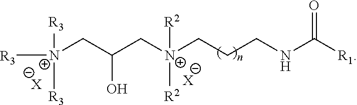

The material (R³)₃N can be any material consistent with the structures described herein for R³. For example, (R³)₃N can be trimethylamine, triethylamine, triethanolamine, dimethylethanolamine or methyl diethanolamine. Preferably, in one aspect, the cationic surfactant is shown in the formula above, with (R³)₃N being selected from trimethylamine, triethylamine, triethanolamine, dimethylethanolamine or methyl diethanolamine and n being 1.

The tertiary amine material source used to treat the gamma hydroxy haloammonium salt to provide a cationic surfactant product can be but not limited to JEFFCAT® Tertiary Amines including N,N-dimethylcyclohexylamine (DMCHA), DMDGA™ N,N-dimethyl-2(2-aminoethoxy)ethanol (ZR-70), Benzyldimethylamine (BDMA), and alkanolamines including trimethanolamine (TEA), dimethylethanolamine (DMEA), and N-methyldiethanolamine (MDEA) from Huntsman. Dimethylethylamine, dimethylaminoethoxyethanol, Lupragen® N 105-N-Methylmorpholine, Lupragen® N 100-N,N-Dimethylcyclohexylamine, N,N-dimethylisopropylamine, trimethylamine, triethylamine, tripropylamine, triethanolamine, dimethylethanolamine, methyldiethanolamine, tris-(2-ethylhexyl)amine, 1,1-Dimethoxy-N,N-dimethyl methanamine, N-Ethyl-N-(2-hydroxyethyl)aniline, N,N-Di-(2-hydroxyethyl)aniline, or diethanol-para-toluidine from BASF.

The amine reacted with HOC(O)—R¹ can be any suitable material consistent with the possible structures and values described herein for R², n1, n2, E, and n. For example, the amine can be dimethylaminopropylamine (DMAPA).

Prior to the hydrohalide reaction, the amidoamine intermediate can have any suitable acid value (AV) (i.e., the mass of potassium hydroxide needed in mg to neutralize one gram of emulsifier and is determined by AOCS Te 1a-64). The intermediate can have an acid value of about 0 to about 20 mg KOH/g, or about 0 to about 10 mg KOH/g, or about 0, or less than, equal to, or greater than about 2, 4, 6, 8, 10, 12, 14, 16, 18, or about 20 mg KOH/g or more.

Prior to the hydrohalide reaction, the amidoamine intermediate can have any total amine value (TAV) (i.e., the mass of potassium hydroxide equivalent to basicity of one gram of sample as determined by AOCS Tf 1a-64). The intermediate can have a TAV of about 100 to about 200 mg KOH/g, or about 150 to about 200 mg KOH/g, or about 100, or less than, equal to, or greater than about 200 mg KOH/g or more.

In some aspects, the present invention provides a method of forming the tertiary amine-based cationic surfactant. The method of forming the cationic surfactant can include acidifying an amine having the structure

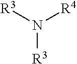

to provide an ammonium salt. The variable R⁴ can be chosen from a substituted or unsubstituted (C₄-C₂₂)alkyl and a substituted or unsubstituted (C₄-C₂₂)alkenyl, such as (C₁₀-C₂₀)alkyl, (C₁₀-C₁₄)alkyl, or C₁₂alkyl. In some aspects, R⁴ can be chosen from a substituted or unsubstituted (C₁-C₁₀)alkyl alcohol, such as butanol, ethanol, methanol or (C₁-C₁₀)alkoxyalcohol, such as ethoxyethanol or methoxyethanol. In various embodiments, the R³ groups of the amine can be independently selected from a methyl, ethyl, or substituted or unsubstituted (C₁-C₁₀)alkyl alcohol, such as ethanol or methanol. In some aspects, R³ can be chosen from substituted or unsubstituted (C₁-C₁₀)alkoxyalcohol, such as ethoxyethanol or methoxyethanol. The method can include treating the ammonium salt with an epihalohydrin to provide a gamma hydroxy haloammonium salt. In some aspects, the epihalohydrin is formed from glycerin, such as glycerin from biodiesel. The method can include treating the gamma hydroxy haloammonium salt with (R³)₃N, to provide the cationic surfactant. The R⁴ group can be derived from a bio-based fatty acid source of a petrochemical fatty acid source. R⁴ can be modified or unmodified. Modification can include maleic anhydride modification, polymerization, ene-reaction modified, hydrogenation, isomerization, branching, or a combination thereof. The material (R³)₃N can be any material consistent with the structures described herein for R³. For example, (R³)₃N can be trimethylamine, triethylamine, triethanolamine, or methyldiethanolamine.

A tertiary amine material source that is acidified to provide an ammonium salt intermediate to provide a cationic surfactant product can be FARMIN DM8665, FARMIN DM6098, FARMIN DM2098, FARMIN DM8098, from Kao Chemicals and Dimethyldodecylamine (DIMLA)-12 from Eastman. JEFFCAT® Tertiary Amines including N,N-dimethylcyclohexylamine (DMCHA), DMDGA™ N,N-dimethyl-2(2-aminoethoxy)ethanol (ZR-70), Benzyldimethylamine (BDMA), and alkanolamines including trimethanolamine (TEA), dimethylethanolamine (DMEA), and N-methyldiethanolamine (MDEA) from Huntsman. Dimethylethylamine, dimethylaminoethoxyethanol, Lupragen® N 105-N-Methylmorpholine, Lupragen® N 100-N,N-Dimethylcyclohexylamine, N,N-dimethylisopropylamine, trimethylamine, triethylamine, tripropylamine, triethanolamine, dimethylethanolamine, methyldiethanolamine, tris-(2-ethylhexyl)amine, 1,1-Dimethoxy-N,N-dimethyl methanamine, N-Ethyl-N-(2-hydroxyethyl)aniline, N,N-Di-(2-hydroxyethyl)aniline, or diethanol-para-toluidine from BASF.

Acid value of fatty acids or oils used to form the cationic surfactant can be 0 to 300 mg KOH/g or from about 100 to 300 mg KOH/g. Prior to amidation, the starting material can have an iodine value prior to amidation from about 5 to 200, or from about 5 to about 180, or from about 5 to about 160. Iodine Value (IV) as used herein is the mass of iodine in grams that is consumed by 100 grams of a material being measured. IV is a measure of the unsaturation (e.g., in fatty acids) present in a material.

The tertiary amine prior to hydrohalide reaction and Menshutkin reaction can have any suitable TAV. The tertiary amine can have a TAV of about from 150 to 1000 mg KOH/g, or about 300 to 1000 mg KOH/g, or about 500 to 1000 mg KOH/g.

The intermediate can have any suitable amine hydrohalide value (AHV) (i.e., the mass of potassium hydroxide in mg equivalent to neutralize one gram of the intermediate surfactant). The hydrohalide salts intermediate post-hydrohalide reaction and post-epichlorohydrin reaction can have an AHV of about 0 to about 150 mg KOH/g, or about 60 to about 110 mg KOH/g, or about 50 or less, or less than, equal to, or greater than about 60. Both the intermediate and the final product can have any chloride concentration (i.e., the mass of silver nitrate needed in mg to form a precipitate of silver chloride in the solution). The intermediate and the final product can have a chloride concentration of 3 to 8% by weight of the solution.

### Asphalt Emulsion Including the Cationic Emulsion.

Various aspects of the present invention provide an asphalt emulsion including the cationic latex emulsion of the present invention. The asphalt emulsion can include bitumen, an aqueous liquid, and the cationic latex emulsion of the present invention. The asphalt emulsion can be a cationic asphalt emulsion that includes cationic bitumen particles. The asphalt emulsion can include the cationic latex emulsion of the present invention and cationic bitumen particles.

Bitumen can form any suitable proportion of the asphalt emulsion. For example, the bitumen can be 1 wt % to 99 wt % of the asphalt emulsion, 50 wt % to 75 wt %, or 1 wt % or more, or less than, equal to, or greater than 2 wt %, 4, 6, 8, 10, 12, 14, 16, 18, 20, 25, 30, 35, 40, 45, 50, 55, 60, 65, 70, 75, 80, 85, 90, 92, 94, 96, 98 wt %, or 99 wt % or less of the asphalt emulsion.

The aqueous liquid can be any suitable proportion of the asphalt emulsion. For example, the aqueous liquid can be 0.1 wt % to 50 wt %, or 1 wt % to 40 wt %, or 0.1 wt % or more, or less than, equal to, or greater than 0.5 wt %, 1 wt %, 2, 4, 6, 8, 10, 12, 14, 16, 18, 20, 25, 30, 35, 40, 45 wt %, or 50 wt % or less of the asphalt emulsion.

The cationic surfactant can be any suitable proportion of the asphalt emulsion. For example, the cationic surfactant can be 0.001 wt % to 25 wt % of the asphalt emulsion, 0.01 wt % to 10 wt %, or 0.001 wt % or more, or less than, equal to, or greater than 0.005 wt %, 0.01, 0.05, 0.1, 0.5, 1, 2, 3, 4, 5, 6, 7, 8, 9, 10, 12, 14, 16, 18, 20 wt %, or 25 wt % or less of the asphalt emulsion.

The cationic latex emulsion can be any suitable proportion of the asphalt emulsion. For example, the cationic latex emulsion can be 0.01 wt % to 50 wt % of the asphalt emulsion, or 0.1 wt % to 25 wt %, or 0.01 wt % or more, or less than, equal to, or greater than 0.05 wt %, 0.1, 0.5, 1, 2, 3, 4, 5, 6, 7, 8, 9, 10, 12, 14, 16, 18, 20, 25, 30, 35, 40, 45 wt %, or 50 wt % or less of the asphalt emulsion.

### Method of Forming the Asphalt Emulsion.

Various aspects of the present invention provide a method of forming the asphalt emulsion of the present invention. The method can be any suitable method that forms the asphalt emulsion including the cationic latex emulsion. For example, the method can include combining a cationic asphalt emulsion with the cationic latex emulsion, to form the asphalt emulsion. The method can include pre-blending a cationic latex with the aqueous salts solution and co-milling of the molten asphalt and latex incorporated aqueous salts solution to form the asphalt emulsion.

### Method of Coating a Carpet.

Various aspects of the present invention provide a method of coating a carpet to form a carpet back coating using the cationic surfactant or cationic latex emulsion of the present invention. For example, the method can include coating the carpet with the cationic latex emulsion to form the carpet back coating thereon.

Paper coating, tires, asphalt concrete, carpet back coating, latex paint, foam, or ink.

In various aspects, the present invention provides a material that includes the cationic surfactant, or that includes the cationic latex emulsion. The material can be any suitable material. For example, in various aspects, the present invention provides a paper coating, tires, asphalt concrete, carpet back coating, latex paint, foam, or ink that includes the cationic surfactant of the present invention or that includes the cationic latex emulsion of the present invention. In some aspects, the material can be made using the cationic latex emulsion, such that the final material includes the cationic latex emulsion or the cationic surfactant. The lipophilic and/or hydrophilic portions of the surfactant can be tuned (e.g., adjusted in length) to achieve a desired performance of the surfactant in end-use applications.

### EXAMPLES

Various embodiments of the present invention can be better understood by reference to the following Examples which are offered by way of illustration. The present invention is not limited to the Examples given herein.

As used herein, total amine value (TAV) refers to the mass of potassium hydroxide equivalent to basicity of one gram of sample as determined by AOCS Tf 1a-64.

As used herein, amine hydrohalide value (AHV) refers to the mass of potassium hydroxide in mg equivalent to neutralize one gram of the intermediate surfactant.

As used herein, chloride concentration refers to the mass of silver nitrate needed in mg to form a precipitate of silver chloride in the solution.

As used herein, acid value (AV) refers to the mass of potassium hydroxide needed in mg to neutralize one gram of emulsifier and is determined by AOCS Te 1a-64.

Various materials used in the Examples 1-4 for preparation of amidoamine-based hydroxy propyl diammonium halide salts using different types of fatty acid and oils are described in Table 1. Table 2 illustrates various amine materials containing different fatty backbone chains used for preparation of tertiary amine-based hydroxy propyl diquaternary ammonium hydrohalide salts. Table 3 illustrates the amine starting material with different polar profile used in the Examples 5, 10, and 11 for preparation of both tertiary amine and amidoamine-based cationic surfactant.

TABLE 1
Fatty acids and oils used for preparation of amidoamine-based hydroxy propyl
diammonium halide salts.

| Fatty Acid/Oil sample | % purity |
|---|---|
| Distilled Tallow FA1 | 99.00 |
| Tall Oil FA1 | 85.00 |
| Palm FA | 85.89 |
| Hydrogenated Tallow | 99.00 |
| FA1 | |
| Whole cut coconut FA | 99.40 |
| Palm Distillate FA | 61.36 |
| Vegetable derived | 90.22 |
| distillate FA 1 | |
| Vegetable derived | 87.56 |
| distillate FA 2 | |
| Soy distillate FA | 95.77 |
| Tallow FA2 | 97.51 |
| Hydrogenated Tallow FA | 97.68 |
| Soybean Oil | 77.10 |
| Tall Oil FA2 | 91.78 |
| RBD Soybean oil | 77.11 |
| Stearic Acid | 99.00 |
| Vegetable derived stearic | 89.00 |
| FA | |

TABLE 2
Materials used for preparation of tertiary amine-based hydroxy
propyl diquaternary ammonium hydrohalide salts.

| | Composition (%) | | | |
|---|---|---|---|---|
| Tertiary Amine | C12:0 | C14:0 | C16:0 | C18:0 |
| Dimethyl Dodecylamine | 98.00 | | | |
| Alkyl (C14-C18) Dimethylamine | | 4.00 | 31.00 | 64.00 |
| Hexadecyldimethylamine | | | 98.00 | |
| Alkyl (C16-C18) Dimethylamine | | | | 98.00 |
| Dimethyltetradecylamine | 2.00 | 97.00 | | |

TABLE 3
Amine materials with different polar functionalities used to react
with the gamma hydroxy epihalohydrin intermediate for
preparation of amidoamine and tertiary amine-based hydroxy
propyl diquaternary ammonium hydrohalide salts.
Type of amines
Trimethylamine
Dimethylethanolamine
Methyl diethanolamine

Scheme 1 illustrates the reactions performed in Examples 1, 2, 3, and 4 forming the amidoamine based surfactant or surfactant composition with a range of fatty acid tails including coconut fatty acids, vegetable derived distillate acids, and hydrogenated distillate stearic fatty acids.

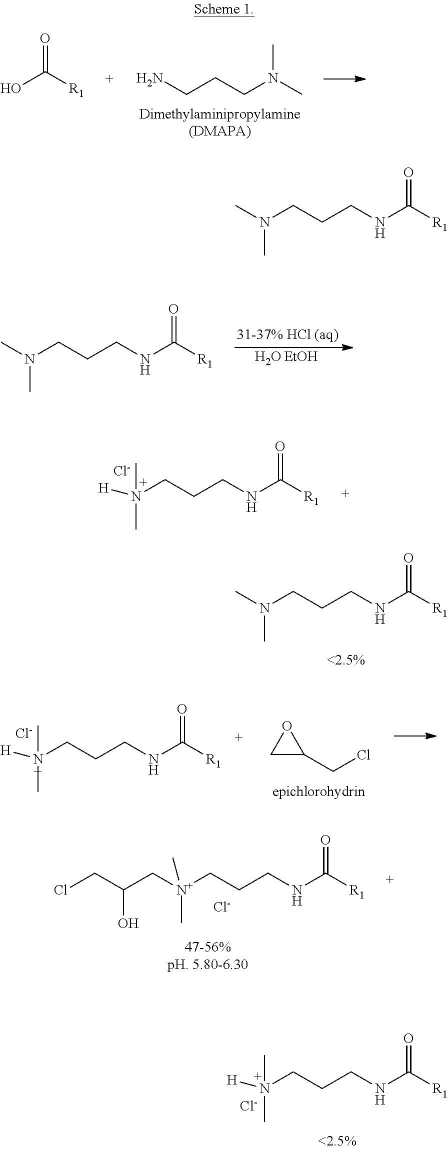

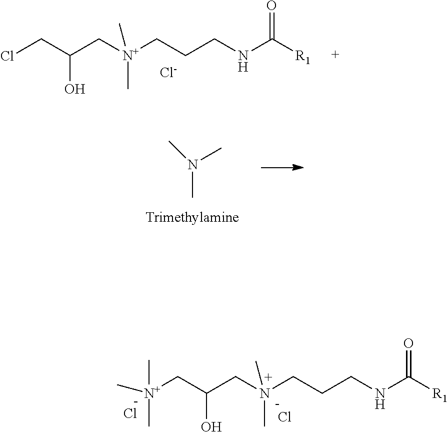

### Example 1. Hydroxy Propyl Di-Quaternary Ammonium Compound of Coconut Fatty Acid and DMAPA Amidoamine Made with Trimethylamine (TMA) in Ethanol

In the present example, one pot multi-step synthesis of Amides, coco, N-[3-(dimethylamino)propyl] was carried out in a 1 L round bottom flask. 103.05 g of coconut fatty acids (1 mol) and 55.74 g of dimethylaminopropylamine (DMAPA) (1.10 mol) were added to a 1 L round bottom flask under a distillation system. The mixture was heated to 120° C. for 30 minutes to allow the salt intermediates to melt. Reaction was then continued at 160-170° C. to undergo amidation under a nitrogen gas sparge (150-300 L/hr). Both the TAV and AV were closely monitored throughout the reaction. The reaction was deemed complete once the AV levels were within 0-10 mg KOH/g, indicating a desired level of fatty acid containing material consumption. The amidoamine adduct had a TAV of 183.04 mg KOH/g and an AV of 8.24 mg KOH/g. Upon completion of amidoamine adduct (1.00 mol), 105.40 g of ethanol and 30.00 g of deionized water were charged in a 1 L round bottom flask, mixed and refluxed for 10 minutes in order to keep the liquidity of the salt adduct after hydrochloric acid solution addition. 47.64 g of 31-37% hydrochloric acid solution (0.98 mol) was added dropwise in the reaction with an addition funnel. The mixture was heated to 60° C. under reflux for 3-5 hours to form an amine hydrochloride salt. The reaction was monitored by AHV and TAV until the TAV was within 0-5 mg KOH/g. Amine hydrochloride salts had an AHV of 91.25 mg KOH/g and a TAV of 2.83 mg KOH/g. After 3-5 hours of reaction, 46.24 g of epichlorohydrin (0.97 mol) was added drop-wise to the reaction and was continued at 80° C. for 5-7 hours to form 3-chloro-N-(3-cocoamidopropyl)-2-hydroxy-N,N-dimethylpropan-1-aminium chloride (1:1) intermediate. Reaction was monitored by AHV and chloride titration. The intermediate had an AHV of 2.85 mg KOH/g and a chloride concentration of 5.10%. Reaction temperature was cooled down to 50-60° C. prior to trimethylamine addition. 49.62 g of trimethylamine, 50% solution in water (0.80 mol) was added dropwise into the reaction and was continued stirring for 3-5 hours at 70-80° C. Reaction was monitored by chloride titration and TAV. The final product had a TAV of 1.29 mg KOH/g and chloride concentration of 7.52%.

### Example 2. Hydroxy Propyl Di-Quaternary Ammonium Compound of Distillate Fatty Acids and DMAPA Amidoamine in Ethanol

67.85 g (1 mol) of a distillate from soybean processing and 26.15 g of dimethylaminopropylamine (DMAPA) (1.07 mol) were added to a 500 mL round bottom flask under distillation system. The mixture was heated to 120° C. for 30 minutes to allow the salt intermediates to melt. Reaction was then continued at 160-170° C. to undergo amidation under a nitrogen gas sparge (150-300 L/hr). Both the TAV and AV were closely monitored throughout the reaction. The reaction was deemed complete once the AV levels were within 0-10 mg KOH/g, indicating a desired level of fatty acid containing material consumption. The amidoamine adduct had a TAV of 161.18 mg KOH/g and an AV of 6.71 mg KOH/g. Upon completion of amidoamine adduct (1.00 mol), 76.89 g of ethanol and 24.00 g of deionized water were charged in a 500 mL round bottom flask, mixed, and refluxed for 10 minutes under nitrogen blanket followed by dropwise addition of 25.05 g of 31-37% hydrochloric acid solution (0.98 mol) in the reaction with an addition funnel. The mixture was heated to 60° C. under reflux for 3-5 hours to form an amine hydrochloride salt. The reaction was monitored by AHV and TAV until the TAV was within 0-5 mg KOH/g. Amine hydrochloride salts had an AHV of 65.25 mg KOH/g and a TAV of 3.88 mg KOH/g. After 3-5 hours of reaction, 24.35 g of epichlorohydrin (0.97 mol) was added drop-wise to the reaction and was continued at 80° C. for 5-7 hours to form the soya, N-(3-dimethylamino)propyl)hydrochloride (1:1) intermediate, wherein the R-amido group corresponds to the fatty acid converted to an amide. Reaction was monitored by AHV and chloride titration. The intermediate had an AHV of 4.12 mg KOH/g and a chloride concentration of 3.33%. Reaction temperature was cooled down to 50-60° C. prior to Trimethylamine addition. 29.60 g of Trimethylamine, 50% solution in water (0.90 mol) was added dropwise into the reaction and was continued stirring for 3-5 hours at 70-80° C. Reaction was monitored by chloride titration and TAV. The final product, N¹-(3-soyamidopropyl)-2-hydroxy-N¹,N¹,N³,N³,N³-pentamethylpropane-1,3-diaminium chloride (1:2), had a chloride concentration of 5.71%.

### Example 3. Hydroxy Propyl Di-Quaternary Ammonium Compound of Hydrogenated Distillate Stearic Fatty Acids and DMAPA Amidoamine Made with Trimethylamine (TMA) in Diethylene Glycol

Fatty acids derived from vegetable oil processing streams such as hydrogenated distillates can be used as a desirable and unique source of fatty acids. 45.79 g (1 mol) of a distillate stearic fatty acid was melted and 18.47 g of Dimethylaminopropylamine (DMAPA) (1.07 mol) were added to a 500 mL round bottom flask under distillation system. The mixture was heated to 120° C. for 30 minutes to allow the salt intermediates to melt. Reaction was then continued at 160-170° C. to undergo amidation under a nitrogen gas sparge (150-300 L/hr). Both the TAV and AV were closely monitored throughout the reaction. The reaction was deemed complete once the AV levels were within 0-10 mg KOH/g, indicating a desired level of fatty acid containing material consumption. The amidoamine adduct had a TAV of 158.53 mg KOH/g and an AV of 1.19 mg KOH/g. Upon completion of amidoamine adduct (1.00 mol), 75.81 g of diethylene glycol and 15.00 g of deionized water were charged in a 500 mL round bottom flask, mixed, and refluxed for 10 minutes under nitrogen blanket followed by dropwise addition of 18.05 g of 31-37% hydrochloric acid solution (0.98 mol) in the reaction with an addition funnel. Diethylene glycol was selected to keep the liquidity of the salts adduct. The mixture was heated to 60° C. under reflux for 3-5 hours to form an amine hydrochloride salt. The reaction was monitored by AHV and TAV until the TAV was within 0-5 mg KOH/g. Amine hydrochloride salts had an AHV of 69.79 mg KOH/g and a TAV of 1.54 mg KOH/g. After 3-5 hours of reaction, 17.07 g of epichlorohydrin (0.97 mol) was added drop-wise to the reaction and was continued at 80° C. for 5-7 hours to form 3-chloro-2-hydroxy-N,N-dimethyl-N-(3-stearamidopropyl)propan-1-aminium chloride (1:1) intermediate. Reaction was monitored by AHV and chloride titration. The intermediate had an AHV of 2.21 mg KOH/g and a chloride concentration of 3.71%. Reaction temperature was cooled down to 50-60° C. prior to Trimethylamine addition. 20.58 g of trimethylamine, 50% solution in water (0.95 mol) was added dropwise into the reaction and was continued stirring for 3-5 hours at 70-80° C. Reaction was monitored by chloride titration and TAV. The final product, 2-hydroxy-N¹,N¹,N¹,N³,N³-pentamethyl-N³-(3-stearamidopropyl)propane-1,3-diaminium chloride (1:2), had a TAV of 2.49 mg KOH/g and a chloride concentration of 5.05%.

### Example 4. Hydroxy Propyl Di-Quaternary Ammonium Compound of Distillate Fatty Acids and DMAPA Amidoamine Made with Trimethylamine (TMA) in Diethylene Glycol

Fatty acids derived from vegetable oil processing streams such as distillates can be used as a desirable and unique source of fatty acids. 67.85 g (1 mol) of a distillate from soybean processing and 26.15 g of dimethylaminopropylamine (DMAPA) (1.07 mol) were added to a 500 mL round bottom flask under distillation system. The mixture was heated to 120° C. for 30 minutes to allow the salt intermediates to melt. Reaction was then continued at 160-170° C. to undergo amidation under a nitrogen gas sparge (150-300 L/hr). Both the TAV and AV were closely monitored throughout the reaction. The reaction was deemed complete once the AV levels were within 0-10 mg KOH/g, indicating a desired level of fatty acid containing material consumption. The amidoamine adduct had a TAV of 161.18 mg KOH/g and an AV of 6.71 mg KOH/g. Upon completion of amidoamine adduct (1.00 mol), 105 g of diethylene glycol and 24.00 g of deionized water were charged in a 500 mL round bottom flask, mixed, and refluxed for 10 minutes under nitrogen blanket followed by dropwise addition of 25.17 g of 31-37% hydrochloric acid solution (0.98 mol) in the reaction with an addition funnel. Diethylene glycol was selected to keep the liquidity of the salts adduct. The mixture was heated to 60° C. under reflux for 3-5 hours to form an amine hydrochloride salt. The reaction was monitored by AHV and TAV until the TAV was within 0-5 mg KOH/g. Amine hydrochloride salts had an AHV of 67.62 mg KOH/g and a TAV of 4.98 mg KOH/g. After 3-5 hours of reaction, 23.99 g of epichlorohydrin (0.97 mol) was added drop-wise to the reaction and was continued at 80° C. for 5-7 hours to form the 3-chloro-N-(3-R-amidopropyl)-2-hydroxy-N,N-dimethylpropan-1-aminium chloride (1:1) intermediate, wherein the R-amido group corresponds to the fatty acid converted to an amide. Reaction was monitored by AHV and chloride titration. The intermediate had an AHV of 4.71 mg KOH/g and a chloride concentration of 3.53%. Reaction temperature was cooled down to 50-60° C. prior to Trimethylamine addition. 29.26 g of Trimethylamine, 50% solution in water (0.90 mol) was added dropwise into the reaction and was continued stirring for 3-5 hours at 70-80° C. Reaction was monitored by chloride titration and TAV. The final product, N¹-(3-soyamidopropyl)-2-hydroxy-N¹,N¹,N³,N³,N³-pentamethylpropane-1,3-diaminium chloride (1:2), had a chloride concentration of 5.44%.

Scheme 2 illustrates the reaction performed in Example 5 forming the amidoamine based surfactant or surfactant composition with a quaternary ammonium cation consisting of two alkyl ethanol polar functionality groups and one methyl group.

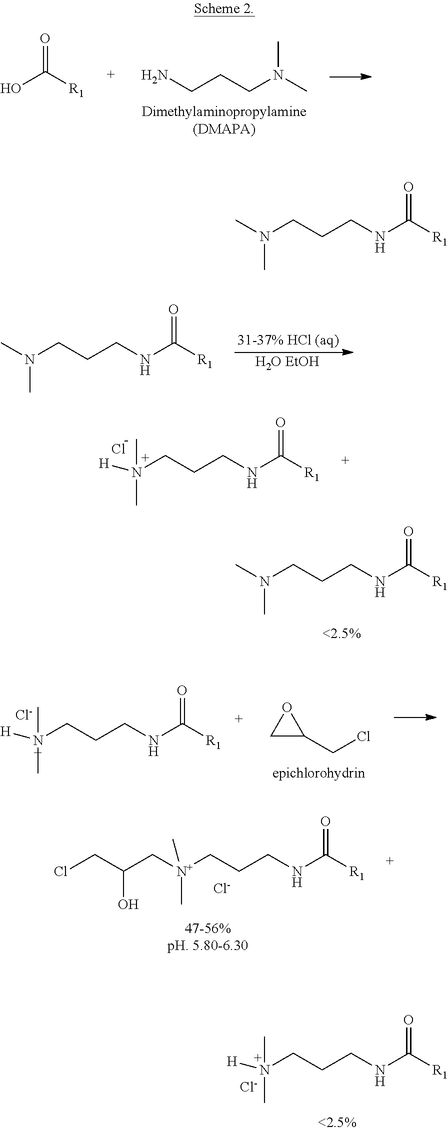

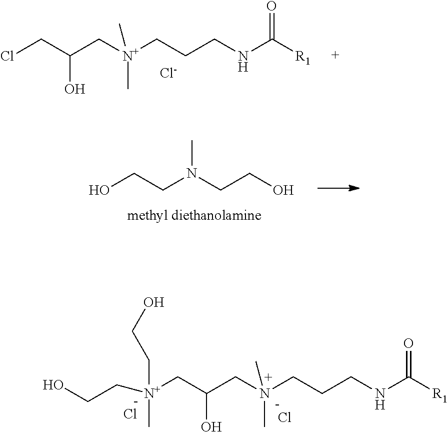

### Example 5. Hydroxy Propyl Di-Quaternary Ammonium Compound of Coconut Fatty Acid and DMAPA Amidoamine Made with Methyldiethanolamine (MDEA) in Ethanol

Coconut Fatty acids can be used as a desirable and unique source of fatty acids. 343.66 g (1 mol) of Coconut Fatty acids and 185.88 g of dimethylaminopropylamine (DMAPA) (1.10 mol) were added to a 1000 mL round bottom flask under distillation system. The mixture was heated to 120° C. for 30 minutes to allow the salt intermediates to melt. Reaction was then continued at 160-170° C. to undergo amidation under a nitrogen gas sparge (150-300 L/hr). Both the TAV and AV were closely monitored throughout the reaction. The reaction was deemed complete once the AV levels were within 0-10 mg KOH/g, indicating a desired level of fatty acid containing material consumption. The amidoamine adduct had a TAV of 190.13 mg KOH/g and an AV of 7.11 mg KOH/g. Upon completion of amidoamine adduct (1.00 mol), 158.73 g of ethanol and 43.18 g of deionized water were charged in a 1000 mL round bottom flask, mixed, and refluxed for 10 minutes under nitrogen blanket followed by dropwise addition of 66.18 g of 31-37% hydrochloric acid solution (0.98 mol) in the reaction with an addition funnel. The mixture was heated to 60° C. under reflux for 3-5 hours to form an amine hydrochloride salt. The reaction was monitored by AHV and TAV until the TAV was within 0-5 mg KOH/g. Amine hydrochloride salts had an AHV of 80.59 mg KOH/g and a TAV of 3.79 mg KOH/g. After 3-5 hours of reaction, 61.37 g of epichlorohydrin (0.97 mol) was added drop-wise to the reaction and was continued at 80° C. for 5-7 hours to form the alkyl chloride intermediate, wherein the R-amido group corresponds to the fatty acid converted to an amide. Reaction was monitored by AHV and chloride titration. The intermediate had an AHV of 3.81 mg KOH/g and a chloride concentration of 3.33%. Reaction temperature was cooled down to 50-60° C. prior to Trimethylamine addition. 76.90 g of Methyldiethanolamine (0.95 mol) was added dropwise into the reaction and was continued stirring for 3-5 hours at 70-80° C. Reaction was monitored by chloride titration and TAV. The final diquat product had a chloride concentration of 6.82%.

Scheme 3 illustrates the reactions performed in Examples 6, 7, and 8, forming the tertiary amine-based surfactant or surfactant composition with varying degrees of fatty tail length pertaining the dodecyl-, hexadecyl-, and octadecyl-fatty tail of the surfactant.

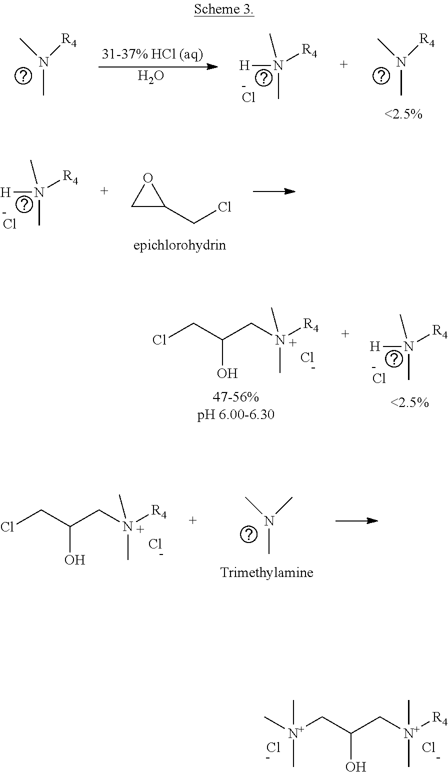

### Example 6. N¹-dodecyl-2-hydroxy-N¹,N¹,N³,N³,N³-pentamethylpropane-1,3-diaminium chloride (1:2) in Diethylene Glycol

43.10 g of dimethylaurylamine (N,N-dimethyldodecylamine, 1.00 mol) was charged in a 500 mL flask. 40.00 g of diethylene glycol and 10.00 g of deionized water were charged in a 500 mL round bottom flask, mixed, and refluxed for 10 minutes under nitrogen blanket followed by dropwise addition of 19.46 g of 31-37% hydrochloric acid solution (0.98 mol) in the reaction with an addition funnel. Diethylene glycol was selected to keep the liquidity of the salts adduct. The mixture was heated to 60° C. under reflux for 3-5 hours to form an amine hydrochloride salts. The reaction was monitored by AHV and TAV until the TAV was within 0-5 mg KOH/g. Amine hydrochloride salts had an AHV of 101.02 mg KOH/g and a TAV of 1.35 mg KOH/g. After 3-5 hours of reaction, 17.55 g of epichlorohydrin (0.97 mol) was added drop-wise to the reaction and was continued at 80° C. for 5-7 hours to form N-(3-chloro-2-hydroxypropyl)-N,N-dimethyldodecan-1-aminium chloride (1:1) intermediate. Reaction was monitored by AHV and chloride titration. The intermediate had an AHV of 4.26 mg KOH/g and a chloride concentration of 5.17%. Reaction temperature was cooled down to 50-60° C. prior to trimethylamine addition. 21.25 g of trimethylamine, 50% solution in water (0.90 mol) was added dropwise into the reaction and was continued stirring for 3-5 hours at 70-80° C. Reaction was monitored by chloride titration and TAV. The final product, N¹-dodecyl-2-hydroxy-N¹,N¹,N³,N³,N³-pentamethylpropane-1,3-diaminium chloride (1:2), had an TAV of 3.22 mg KOH/g and a chloride concentration of 7.65%.

### Example 7. N¹-hexadecyl-2-hydroxy-N¹,N¹,N³,N³,N³-pentamethylpropane-1,3-diaminium chloride (1:2) in Diethylene Glycol

43.10 g of N,N-dimethylhexadecylamine (1.00 mol) was charged in a 500 mL flask. 55.08 g of diethylene glycol and 25.00 g of deionized water were charged in a 500 mL round bottom flask, mixed, and refluxed for 10 minutes under nitrogen blanket followed by dropwise addition of 15.44 g of 31-37% hydrochloric acid solution (0.98 mol) in the reaction with an addition funnel. Diethylene glycol was selected to keep the liquidity of the salts adduct. The mixture was heated to 60° C. under reflux for 3-5 hours to form an amine hydrochloride salts. The reaction was monitored by AHV and TAV until the TAV was within 0-5 mg KOH/g. Amine hydrochloride salts had an AHV of 68.27 mg KOH/g and a TAV of 2.79 mg KOH/g. After 3-5 hours of reaction, 14.06 g of epichlorohydrin (0.97 mol) was added drop-wise to the reaction and was continued at 80° C. for 5-7 hours to form N-(3-chloro-2-hydroxypropyl)-N,N-dimethylhexadecan-1-aminium chloride (1:1) intermediate. Reaction was monitored by AHV and chloride titration. The intermediate had an AHV of 3.68 mg KOH/g and a chloride concentration of 3.60%. Reaction temperature was cooled down to 50-60° C. prior to trimethylamine addition. 16.88 g of trimethylamine, 50% solution in water (0.95 mol) was added dropwise into the reaction and was continued stirring for 3-5 hours at 70-80° C. Reaction was monitored by chloride titration and TAV. The final product, N¹-hexadecyl-2-hydroxy-N¹,N¹,N³,N³,N³-pentamethylpropane-1,3-diaminium chloride (1:2), had a TAV of 0.95 mg KOH/g and a chloride concentration of 6.40%.

### Example 8. 1,3-Propanediaminium, 2-hydroxy-N¹,N¹,N¹,N³,N³-pentamethyl-N³-octadecyl-, chloride (1:2) in Diethylene Glycol

65.00 g of N,N-octadecyldimethylamine (1.00 mol) was charged in a 500 mL flask. 79.21 g of diethylene glycol and 20.00 g of deionized water were charged in a 500 mL round bottom flask, mixed, and refluxed for 10 minutes under nitrogen blanket followed by dropwise addition of 21.09 g of 31-37% hydrochloric acid solution (0.98 mol) in the reaction with an addition funnel. Diethylene glycol was selected to keep the liquidity of the salts adduct. The mixture was heated to 60° C. under reflux for 3-5 hours to form an amine hydrochloride salts. The reaction was monitored by AHV and TAV until the TAV was within 0-5 mg KOH/g. Amine hydrochloride salts had an AHV of 65.81 mg KOH/g and a TAV of 2.11 mg KOH/g. After 3-5 hours of reaction, 16.33 g of epichlorohydrin (0.96 mol) was added drop-wise to the reaction and was continued at 80° C. for 5-7 hours to form N-(3-chloro-2-hydroxypropyl)-N,N-dimethylhexadecan-1-aminium chloride (1:1) intermediate. Reaction was monitored by AHV and chloride titration. The intermediate had an AHV of 1.82 mg KOH/g and a chloride concentration of 3.21%. Reaction temperature was cooled down to 50-60° C. prior to trimethylamine addition. 23.49 g of trimethylamine, 50% solution in water (0.95 mol) was added dropwise into the reaction and was continued stirring for 3-5 hours at 70-80° C. Reaction was monitored by chloride titration and TAV. The final product, N¹-octadecyl-2-hydroxy-N¹,N¹,N³,N³,N³-pentamethylpropane-1,3-diaminium chloride (1:2), had a TAV of 1.12 mg KOH/g and a chloride concentration of 6.95%.

### Example 9. N¹-dodecyl-2-hydroxy-N¹,N¹,N³,N³,N³-pentamethylpropane-1,3-diaminium chloride (1:2) in Ethanol

80.00 g of dimethylaurylamine (N,N-dimethyldodecylamine, 1.00 mol) was charged in a 500 mL flask. 70.00 g of ethanol and 15.00 g of deionized water were charged in a 500 mL round bottom flask, mixed, and refluxed for 10 minutes under nitrogen blanket followed by dropwise addition of 36.12 g of 31-37% hydrochloric acid solution (0.98 mol) in the reaction with an addition funnel. The mixture was heated to 60° C. under reflux for 3-5 hours to form an amine hydrochloride salts. The reaction was monitored by AHV and TAV until the TAV was within 0-5 mg KOH/g. Amine hydrochloride salts had an AHV of 117.10 mg KOH/g and a TAV of 1.57 mg KOH/g. After 3-5 hours of reaction, 32.63 g of epichlorohydrin (0.97 mol) was added drop-wise to the reaction and was continued at 80° C. for 5-7 hours to form N-(3-chloro-2-hydroxypropyl)-N,N-dimethyldodecan-1-aminium chloride (1:1) intermediate. Reaction was monitored by AHV and chloride titration. The intermediate had an AHV of 3.53 mg KOH/g and a chloride concentration of 5.02%. Reaction temperature was cooled down to 50-60° C. prior to trimethylamine addition. 36.21 g of trimethylamine, 50% solution in water (0.90 mol) was added dropwise into the reaction and was continued stirring for 3-5 hours at 70-80° C. Reaction was monitored by chloride titration and TAV. The final product, N¹-dodecyl-2-hydroxy-N¹,N¹,N³,N³,N³-pentamethylpropane-1,3-diaminium chloride (1:2), had an TAV of 3.51 mg KOH/g and a chloride concentration of 7.85%.

Scheme 4 illustrates the reactions performed in Example 10, forming the tertiary amine-based surfactant or surfactant composition with a quaternary ammonium cation consisting of two alkyl ethanol polar functionality groups and one methyl group.

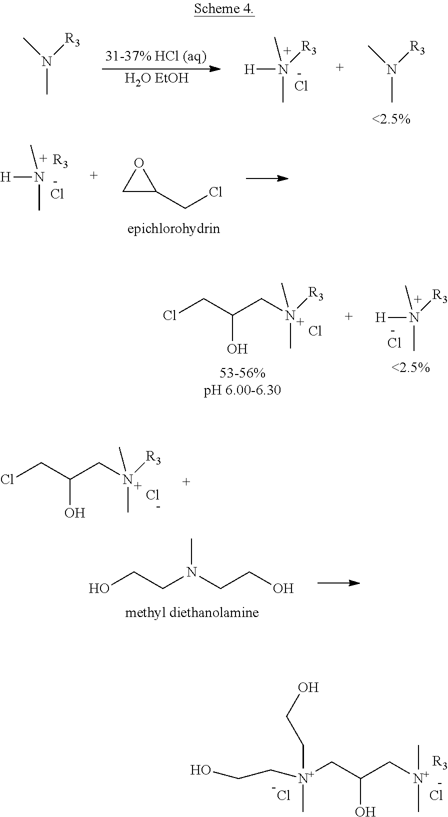

### Example 10. 1,3-Propanediaminium, 2-hydroxy-N¹,N¹-bis(2-hydroxyethyl)-N¹,N³,N³-trimethyl-N³-dodecyl-, chloride (1:2) in Ethanol

48.07 g of dimethylaurylamine (N,N-dimethyldodecylamine, 1.00 mol) was charged in a 500 mL flask. 40.10 g of ethanol and 10.48 g of deionized water were charged in a 500 mL round bottom flask, mixed, and refluxed for 10 minutes under nitrogen blanket followed by dropwise addition of 21.70 g of 31-37% hydrochloric acid solution (0.98 mol) in the reaction with an addition funnel. The mixture was heated to 60° C. under reflux for 3-5 hours to form an amine hydrochloride salts. The reaction was monitored by AHV and TAV until the TAV was within 0-5 mg KOH/g. Amine hydrochloride salts had an AHV of 113.10 mg KOH/g and a TAV of 1.72 mg KOH/g. After 3-5 hours of reaction, 20.05 g of epichlorohydrin (0.97 mol) was added drop-wise to the reaction and was continued at 80° C. for 5-7 hours to form N-(3-chloro-2-hydroxypropyl)-N,N-dimethyldodecan-1-aminium chloride (1:1) intermediate. Reaction was monitored by AHV and chloride titration. The intermediate had an AHV of 4.26 mg KOH/g and a chloride concentration of 5.09%. 22.39 g of methyldiethanolamine (MDEA) was added dropwise into the reaction and was continued stirring for 3-5 hours at 70-80° C. Reaction was monitored by chloride titration and TAV. The final product, 1,3-Propanediaminium, 2-hydroxy-N¹,N¹-bis(2-hydroxyethyl)-N¹,N³,N³-trimethyl-N³-dodecyl-, chloride (1:2) had an TAV of 5.29 mg KOH/g and a chloride concentration of 6.21%.

### Example 11. 1,3-Propanediaminium, N¹-dodecyl-2-hydroxy-N³-(2-hydroxyethyl)-N¹,N¹,N³,N³-tetramethyl-, chloride (1:2)

48.07 g of dimethylaurylamine (N,N-dimethyldodecylamine, 1.00 mol) was charged in a 500 mL flask. 30.10 g of ethanol and 10.48 g of deionized water were charged in a 500 mL round bottom flask, mixed, and refluxed for 10 minutes under nitrogen blanket followed by dropwise addition of 21.70 g of 31-37% hydrochloric acid solution (0.98 mol) in the reaction with an addition funnel. The mixture was heated to 60° C. under reflux for 3-5 hours to form an amine hydrochloride salts. The reaction was monitored by AHV and TAV until the TAV was within 0-5 mg KOH/g. Amine hydrochloride salts had an AHV of 113.10 mg KOH/g and a TAV of 1.72 mg KOH/g. After 3-5 hours of reaction, 20.05 g of epichlorohydrin (0.97 mol) was added drop-wise to the reaction and was continued at 80° C. for 5-7 hours to form N-(3-chloro-2-hydroxypropyl)-N,N-dimethyldodecan-1-aminium chloride (1:1) intermediate. Reaction was monitored by AHV and chloride titration. The intermediate had an AHV of 4.26 mg KOH/g and a chloride concentration of 5.09%. 18.21 g of dimethylethanolamine (DMEA) was added dropwise into the reaction and was continued stirring for 3-5 hours at 70-80° C. Reaction was monitored by chloride titration and TAV. The final product, 1,3-Propanediaminium, N¹-dodecyl-2-hydroxy-N³-(2-hydroxyethyl)-N¹,N¹,N³,N³-tetramethyl-, chloride (1:2) had an TAV of 3.22 mg KOH/g and a chloride concentration of 6.21%.

Following the below procedures, a cationic latex emulsions (e.g. Examples 12-29) were prepared by incorporating different iterations of cationic surfactant (Examples 1-11) into an anionic latex at different levels of surfactant dosage (BWS=by weight of surfactant; BWALS=by weight of anionic latex solids; BWE=by weight of total emulsion). Table 4 illustrates the composition of cationic latex. Some of the described examples 12, 13, 14, 15, and 29 of the cationic latex was further treated with 37% hydrochloric acid solution (37% HCl aq.) down to a pH of 5.30 or in some cases 3.00 (e.g. cationic latex example 29) to further decrease the viscosity of the final cationic latex. It is understood that other organic acids can be used to further lower the pH of the cationic latex emulsions.

TABLE 4
Generic formula of Cationic latex.

| | Cationic latex |
|---|---|
| Component | (Examples 12-29) |
| Anionic latex solids, % BWE | 60-65% |
| Surfactant % BWALS (50-55% Actives, % BWS) | 4-6% |
| Deionized (DI) Water, % BWE | 27-35% |

### Example 12. Preparation of Cationic Latex with Hydroxy Propyl Di-Quaternary Ammonium Compound of Coconut Fatty Acid and DMAPA Amidoamine Made with Trimethylamine (TMA) in Ethanol

150.0 g of the high molecular weight styrene-butadiene copolymer anionic latex with a residue content of 70% was prepared and agitated at 100-500 rpm with a low shear overhead mixer to achieve a homogenous solution at 25° C. A blend of cationic surfactant solution of Example 1 at 4.50% BWALS and DI water were added to the anionic latex slowly with continued agitation for 1 minute. Final cationic latex had a viscosity of 261.00 cP at 25° C. after the solution was sufficiently agitated at 500-1000 rpm for 1 minute. The addition of the 37% HCl solution to a pH of 5.30 did not have any impact on the viscosity of the final mix.

### Example 13. Preparation of Cationic Latex with a Blend of 80% Hydroxy Propyl Di-Quaternary Ammonium Compound of Coconut Fatty Acid and DMAPA Amidoamine Made with Trimethylamine (TMA) in Ethanol and 20% Hydroxy Propyl Di-Quaternary Ammonium Compound of Distillate Fatty Acids and DMAPA Amidoamine in Ethanol

Cationic latex was prepared with a high molecular weight styrene-butadiene copolymer anionic latex with a residue content of 70% following the same procedure as described above in Example 12 with the exception that a blend of cationic surfactant solution of Example 1, Example 2, and water were added to the anionic latex slowly with continued agitation for 1 minute. Significant viscosity build-up was seen in relation to the cationic surfactant blend charge. The solution was sufficiently agitated at 500-1000 rpm until the viscosity reached 690.00 cP at 25° C. pH of the cationic latex was adjusted down to 5.30 by adding 37% hydrochloric acid solution bringing down the pH to 5.30 and viscosity of 285.83 cP.

### Example 14. Preparation of Cationic Latex with a Blend of 50% Hydroxy Propyl Di-Quaternary Ammonium Compound of Coconut Fatty Acid and DMAPA Amidoamine Made with Trimethylamine (TMA) in Ethanol and 50% Hydroxy Propyl Di-Quaternary Ammonium Compound of Distillate Fatty Acids and DMAPA Amidoamine in Ethanol

Cationic latex was prepared with a high molecular weight styrene-butadiene copolymer anionic latex with a residue content of 70% following the same procedure as described above in Example 13. Final cationic latex had a viscosity of 22,830.00 cP at 25° C. pH of the cationic latex was adjusted down to 5.30 by adding 37% hydrochloric acid solution bringing down the pH to 5.30 and viscosity of 679.76 cP.

### Example 15. Preparation of Cationic Latex with Hydroxy Propyl Di-Quaternary Ammonium Compound of Distillate Fatty Acids and DMAPA Amidoamine in Ethanol

Cationic latex was prepared with a high molecular weight styrene-butadiene copolymer anionic latex with a residue content of 70% following the same procedure as described above with the exception that a blend of cationic surfactant solution of Example 2 at 5.20% BWALS and water was used in the formulation. Final cationic latex had a viscosity of 274,600 cP at 25° C. pH of the cationic latex was adjusted down to 5.30 by adding 37% hydrochloric acid solution bringing down the pH to 5.30 and viscosity of 1,092 cP.

### Example 16. Preparation of Cationic Latex with a Blend of 70% Hydroxy Propyl Di-Quaternary Ammonium Compound of Coconut Fatty Acid and DMAPA Amidoamine Made with Trimethylamine (TMA) and 30% Hydroxy Propyl Di-Quaternary Ammonium Compound of Coconut

Cationic latex was prepared with a high molecular weight styrene-butadiene copolymer anionic latex with a residue content of 70% following the same procedure as described above with the exception that a blend of cationic surfactant solution of Example 1, Example 5, and water were added to the anionic latex slowly with continued agitation for 1 minute. Small degree of viscosity build-up was seen in relation to the cationic surfactant blend charge. The solution was sufficiently agitated at 500-1000 rpm until the viscosity reached 352.00 cP at 25° C.

### Example 17. Preparation of Cationic Latex with a Blend of 30% Hydroxy Propyl Di-Quaternary Ammonium Compound of Coconut Fatty Acid and DMAPA Amidoamine Made with Trimethylamine (TMA) and 70% Hydroxy Propyl Di-Quaternary Ammonium Compound of Coconut

Cationic latex was prepared with a high molecular weight styrene-butadiene copolymer anionic latex with a residue content of 70% following the same procedure as described above. Final cationic latex had a viscosity of 1,429.00 cP at 25° C.

### Example 18. Preparation of Cationic Latex with Hydroxy Propyl Di-Quaternary Ammonium Compound of Coconut Fatty Acid and DMAPA Amidoamine Made with Methyldiethanolamine (MDEA)

Cationic latex was prepared with a high molecular weight styrene-butadiene copolymer anionic latex with a residue content of 70% following the same procedure as described above in Example 12 with the exception that a blend of cationic surfactant solution of Example 5 at 4.50% BWALS and water was used. Final cationic latex had a viscosity of 24,080 cP at 25° C.

### Example 19. Preparation of Cationic Latex with N¹-dodecyl-2-hydroxy-N¹,N¹,N³,N³,N³-pentamethylpropane-1,3-diaminium chloride (1:2)

Cationic latex was prepared with a high molecular weight styrene-butadiene copolymer anionic latex with a residue content of 70% following the same procedure as described above with the exception that Example 6 was added to the anionic latex. Final cationic latex had a viscosity of 4,340.00 cP at 25° C.

### Example 20. Preparation of Cationic Latex with N¹-hexadecyl-2-hydroxy-N¹,N¹,N³,N³,N³-pentamethylpropane-1,3-diaminium chloride (1:2)

Cationic latex was prepared with a high molecular weight styrene-butadiene copolymer anionic latex with a residue content of 70% following the same procedure as described above with the exception that Example 7 was added to the anionic latex. Final cationic latex had a viscosity of 6,123.00 cP at 25° C.

### Example 21. Preparation of Cationic Latex with 1,3-Propanediaminium, 2-hydroxy-N¹,N¹,N¹,N³, N³-pentamethyl-N³-octadecyl-, chloride (1:2)

Cationic latex was prepared with a high molecular weight styrene-butadiene copolymer anionic latex with a residue content of 70% following the same procedure as described above in Example 12 with the exception that Example 8 was added to the anionic latex. Significant viscosity build-up was seen in relation to the cationic surfactant blend charge. Final cationic latex had a viscosity of 94,240 cP at 25° C.

### Example 22. Preparation of Cationic Latex with N¹-dodecyl-2-hydroxy-N¹,N¹,N³,N³,N³-pentamethylpropane-1,3-diaminium chloride (1:2)

Cationic latex was prepared with a high molecular weight styrene-butadiene copolymer anionic latex with a residue content of 70% following the same procedure as described above with the exception that Example 9 was added to the anionic latex. Final cationic latex had a viscosity of 454.00 cP at 25° C.

### Example 23. Preparation of Cationic Latex with 1,3-Propanediaminium, 2-hydroxy-N¹,N¹-bis(2-hydroxyethyl)-N¹,N³,N³-trimethyl-N³-dodecyl-, chloride (1:2)

Cationic latex was prepared with a high molecular weight styrene-butadiene copolymer anionic latex with a residue content of 70% following the same procedure as described above with the exception that Example 10 was added to the anionic latex. Final cationic latex had a viscosity of 13,520.00 cP at 25° C.

### Example 24. Preparation of Cationic Latex with Hydroxy Propyl Di-Quaternary Ammonium Compound of Hydrogenated Distillate Stearic Fatty Acids and DMAPA Amidoamine Made with Trimethylamine (TMA)

Cationic latex was prepared with a high molecular weight styrene-butadiene copolymer anionic latex with a residue content of 70% following the same procedure as described above with the exception that Example 3 was added to the anionic latex. Significant viscosity build-up was seen in relation to the cationic surfactant blend charge. Final cationic latex had a viscosity of >500,000 cP at 25° C.

### Example 25. Preparation of Cationic Latex with 1,3-Propanediaminium, N¹-dodecyl-2-hydroxy-N³-(2-hydroxyethyl)-N¹,N¹,N³,N³-tetramethyl-, chloride (1:2)

Cationic latex was prepared with a high molecular weight styrene-butadiene copolymer anionic latex with a residue content of 70% following the same procedure as described above in Example 12 with the exception that Example 11 was added to the anionic latex.

### Example 26. Preparation of Cationic Latex with a Blend of 60% N¹-dodecyl-2-hydroxy-N¹,N¹,N³,N³,N³-pentamethylpropane-1,3-diaminium chloride (1:2) and 40% 1,3-Propanediaminium, 2-hydroxy-N¹,N¹-bis(2-hydroxyethyl)-N¹,N³,N³-trimethyl-N³-dodecyl-, chloride (1:2)

Cationic latex was prepared with a high molecular weight styrene-butadiene copolymer anionic latex with a residue content of 70% following the same procedure as described above. with the exception that a blend of Example 9 and Example 10 was added to the anionic latex. Final cationic latex had a viscosity of 926.00 cP at 25° C.

### Example 27. Preparation of Cationic Latex with a Blend of 40% N¹-dodecyl-2-hydroxy-N¹,N¹,N³,N³,N³-pentamethylpropane-1,3-diaminium chloride (1:2) and 60% 13-Propanediaminium, 2-hydroxy-N¹,N¹-bis(2-hydroxyethyl)-N¹,N³,N³-trimethyl-N³-dodecyl-, chloride (1:2)

Cationic latex was prepared with a high molecular weight styrene-butadiene copolymer anionic latex with a residue content of 70% following the same procedure as described above. Final cationic latex had a viscosity of 1222.00 cP at 25° C.

### Example 28. Preparation of Cationic Latex with a Retail Store Available Liquid Rubber Product: Ames' Liquid Rubber Waterproof Sealer

115 g of carboxylated styrene-butadiene rubber with a residue content of 55-70% was prepared and agitated at 100-500 rpm with a low shear overhead mixer to achieve a homogenous solution at 25° C. A blend of 5.5 g cationic surfactant solution of Example 1 and 4.75 g of water were added to the anionic latex slowly with continued agitation for 1 minute.

### Example 29. Preparation of Cationic Latex with Hydroxy Propyl Di-Quaternary Ammonium Compound of Coconut Fatty Acid and DMAPA Amidoamine Made with Methyldiethanolamine (MDEA)

Cationic latex was prepared from a crosslinked styrene-butadiene copolymer anionic latex with a residue content of 70% following the same procedure as described in 12 with the exception that Example 5 at 4.25% BWALS was added to the anionic latex. 37% HCl solution was added to the latex subsequently to the latex mix. Viscosity was monitored throughout the addition of the HCl soln. at different pH levels from 9.00 to 3.00. Final cationic latex had a viscosity of 455.00 cP at 25° C. and a pH of 3.00.

Different variations of amidoamine and/or tertiary amine-based cationic surfactant using various starting materials can be synthesized, co-blended, and formulated to achieve a desired range of viscosity of the cationic latex by tuning the hydrophilic and hydrophobic profile of the surfactant.

Viscosity of the cationic latex can be adjusted by modification of average fatty chain length per molecule of the both amidoamine and tertiary amine-based cationic latices.

Increase in viscosity of the cationic latex examples 12-15 containing different levels of surfactant example 1 and example 2 by weight ratio, % BWS is seen depending on the type of fatty acid used for preparation of the amidoamine-based cationic surfactant. Table 5 and Graph 1 illustrate the impact of the average fatty chain length of the surfactant on the viscosity of the cationic latex potentially changing the distribution of the cationic latex. It can be noted that the viscosity of the cationic latex is observed with the increase in the ratio of surfactant Example 2 in the cationic latex mix, coupled with the increase in average molecular weight of the surfactant compound. (e.g. Example 12 which is a cationic styrene butadiene latex composed of surfactant example 1 or amidoamine-based cationic surfactant with coconut fatty acid chain had the least viscosity reading compared to the Example 15 latex which is composed of example 2 or cationic surfactant with soy fatty acid chain.)

TABLE 5
Cationic latex emulsion examples 12-15 prepared using amidoamine-based cationic
surfactants with varying average fatty chain length at minimum surfactant dosage required to
convert from anionic latex to cationic latex emulsion. It is understood that the synthesis of the
different types of cationic surfactants made with various starting materials and the blending of
the final product of different types of cationic surfactants are being used interchangeably in the
Examples.

| | | | Approximate | | | |
|---|---|---|---|---|---|---|
| | | | Average | | | |
| | | | Molecular | Minimum | | |
| Cationic | Surfactant | Surfactant | Weight of | surfactant | Viscosity | Viscosity |
| latex | Example 1 | Example 2 | surfactant 1 and | dosage | at pH of | at pH of |
| example | BWS, % | BWS, % | 2 blend (g/mol) | BWALS, % | 5.30 (cP) | 5.30 (cP) |
| 12 | 100 | 0 | 515.50 | 4.00 | 261.00 | 261.00 |
| 13 | 80 | 20 | 530.50 | 4.24 | 285.83 | 285.83 |
| 14 | 50 | 50 | 553.35 | 4.60 | 679.76 | 679.76 |
| 15 | 0 | 100 | 591.19 | 5.20 | 1,092.00 | 1,092.00 |

Notable viscosity change in cationic latex was also observed with varying length of fatty chain of the tertiary amine based cationic surfactant. (e.g. Examples 19-21, viscosity of the cationic latex is increased from 4,340 cP to 94,240 cP choosing from dodecyl or C₁₂H₂₅— to octadecyl or C₁₈H₃₇— fatty tail of the tertiary amine-based surfactant.)

TABLE 6
Cationic latex emulsions prepared using tertiary amine
based cationic surfactants.

| | Cationic Latex | | |
|---|---|---|---|
| | Example | Example | Example |
| Surfactant | 19 | 20 | 21 |
| Example 6, % | 4.50% | 0.00% | 0.00% |
| BWALS | | | |
| Emulsifier #7, % | 0.00% | 5.10% | 0.00% |
| BWALS | | | |
| Emulsifier #8, % | 0.00% | 0.00% | 5.10% |
| BWALS | | | |
| Viscosity of | 4,340.00 | 6,123.00 | 94,240.00 |
| cationic latex (cP) | | | |
| at pH 9.00-10.00 | | | |
| Approximate | 438.44 | 494.07 | 522.12 |
| Average | | | |
| Molecular Weight | | | |
| (MW) of | | | |
| surfactant 6, 7, | | | |
| and8 blend | | | |
| (g/mol) | | | |

Viscosity of the cationic latex can be further adjusted down by adding 31-37% of HCl acid solution to the surfactant incorporated cationic latex. Significant drop in viscosity of the cationic latex emulsion can be seen by further adding 37% HCl acid soln. into the surfactant treated-cationic latices going from pH of 9.00 to 3.00.

Relationship between the type of fatty acids used for the preparation of amidoamine-based cationic surfactant and the viscosity of the pH-adjusted styrene-butadiene copolymer cationic latex examples 12-15 containing different levels of cationic surfactant of example 1 and 2 is observed in Graph 2 and Table 5.

Viscosity of the latex emulsion can be further adjusted by adding 37% HCl acid soln. into the surfactant treated cationic latex to a pH of 3.00. Table 7 and Graph 3 illustrate the relationship between the pH and the viscosity of the cross-linked cationic latex example 29.

TABLE 7
Decrease in viscosity of cationic latex example 29 in
relation to the pH drop of latex

| 37% HCl | | Viscosity |
|---|---|---|
| added, g | pH | (cP) |
| 0.00 | 9.00 | 385,500.00 |
| 0.29 | 8.00 | 200,000.00 |
| 1.59 | 3.89 | 4,633.00 |
| 1.67 | 3.00 | 455.30 |

Increase in viscosity of the cationic latices was also seen depending on the inclusion of polar functionalities of the amine material used for synthesis of the amidoamine-based cationic surfactant. Viscosity of the cationic latex can be adjusted by modification of polar functionalities per molecule of the cationic surfactant as shown in cationic latex examples 12, 16, 17, and 18 containing different levels of surfactant example 1 and example 5. Table 8 and Graph 4 illustrate the impact of varying polar functionalities per molecule of the cationic surfactant on the viscosity of the cationic latex.

TABLE 8
Cationic latex emulsions prepared using amidoamine-based cationic surfactants with
varying hydroxyl functional groups on the terminal quat at a fixed pH of 9.00-10.00.

| | | | Approximate | | |
|---|---|---|---|---|---|
| | | | Average | | |
| | | | Molecular | | Viscosity |
| Cationic | Surfactant | Surfactant | Weight of | Surfactant | at pH of |
| latex | Example 1 | Example 5 | surfactant 1 and | dosage | 9.00-10.00 |
| Example | BWS, % | BWS, % | 5 blend (g/mol) | BWALS, % | (cP) |
| 12 | 100 | 0 | 515.50 | 4.50 | 175.90 |
| 16 | 70 | 30 | 533.82 | 4.50 | 352.00 |
| 17 | 30 | 70 | 558.24 | 4.50 | 1,429.00 |
| 18 | 0 | 100 | 576.55 | 4.50 | 24,080.00 |

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present invention. Thus, it should be understood that although the present invention has been specifically disclosed by specific embodiments and optional features, modification and variation of the concepts herein disclosed may be resorted to by those of ordinary skill in the art, and that such modifications and variations are considered to be within the scope of embodiments of the present invention.

### Exemplary Embodiments

The following exemplary embodiments are provided, the numbering of which is not to be construed as designating levels of importance:

Embodiment 1 provides a cationic latex emulsion comprising:

latex particles;

an aqueous liquid emulsified with the latex particles; and

a cationic surfactant having the structure:

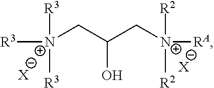

wherein
at each occurrence R² is independently chosen from substituted or unsubstituted linear or branched (C₁-C₆)alkyl, substituted or unsubstituted linear or branched (C₁-C₆)alkenyl, substituted or unsubstituted (C₄-C₁₀)cycloalkyl or (C₄-C₁₀)cycloalkenyl, substituted or unsubstituted (C₁-C₁₀)alkoxy (for example, substituted or unsubstituted (C₁-C₆) alkoxy), including but not limited to (C₁-C₁₀)alkyl alcohol, (C₁-C₁₀)alkyl ether or (C₁-C₁₀)alkoxyalcohol, and substituted or unsubstituted (C₄-C₁₀)aryl, or wherein R² together with another R² forms a substituted or unsubstituted aliphatic or aromatic (C₄-C₁₂)heterocycle together with the nitrogen to which they are attached;
at each occurrence R³ is independently chosen from substituted or unsubstituted linear or branched (C₁-C₆)alkyl, substituted or unsubstituted linear or branched (C₁-C₆)alkenyl, substituted or unsubstituted (C₄-C₁₀)cycloalkyl or (C₄-C₁₀)cycloalkenyl, substituted or unsubstituted (C₁-C₁₀)alkoxy (for example, substituted or unsubstituted (C₁-C₆) alkoxy), including but not limited to (C₁-C₁₀)alkyl alcohol, (C₁-C₁₀)alkyl ether or (C₁-C₁₀)alkoxyalcohol and substituted or unsubstituted (C₄-C₁₀)aryl, or wherein R³ together with another R³ forms a substituted or unsubstituted aliphatic or aromatic (C₄-C₁₂)heterocycle together with the nitrogen to which they are attached;
at each occurrence X⁻ is independently chosen from an anion;
R^{A} is chosen from a substituted or unsubstituted (C₄-C₂₂)alkyl, a substituted or unsubstituted (C₄-C₂₂)alkenyl, and

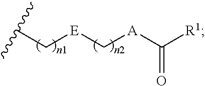

R¹ is chosen from a substituted or unsubstituted (C₄-C₂₂)alkyl and a substituted or unsubstituted (C₄-C₂₂)alkenyl, wherein R¹ is optionally modified, the modification comprising maleic anhydride modification, polymerization, ene-reaction modified, hydrogenation, isomerization, branching, or a combination thereof;
A is —NH— or —O—;
E is —CH₂—, —((C₂-C₄)alkoxy)ₙ₃-, or —O—;
n1 is an integer that is 0 to 9;
n2 is an integer that is 0 to 9;
n1+n2 is 1 to 10; and
n3 is an integer that is 1 to 40.

Embodiment 2 provides the cationic latex emulsion of Embodiment 1, wherein E is —CH₂—.

Embodiment 3 provides the cationic latex emulsion of any one of Embodiments 1-2, wherein at each occurrence R² is independently chosen from substituted or unsubstituted (C₁-C₆)alkyl and substituted or unsubstituted (C₁-C₆)alkyl alcohol.

Embodiment 4 provides the cationic latex emulsion of any one of Embodiments 1-3, wherein at each occurrence R³ is independently chosen from substituted or unsubstituted (C₁-C₆)alkyl and substituted or unsubstituted (C₁-C₆)alkyl alcohol.

Embodiment 5 provides the cationic latex emulsion of any one of Embodiments 1-4, wherein R^{A} is chosen from a substituted or unsubstituted (C₄-C₂₂)alkyl, a substituted or unsubstituted (C₄-C₂₂)alkenyl, and

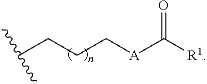

Embodiment 6 provides the cationic latex emulsion of any one of Embodiments 1-5, wherein:

at each occurrence R² is independently chosen from substituted or unsubstituted (C₁-C₆)alkyl;

at each occurrence R³ is independently chosen from substituted or unsubstituted (C₁-C₆)alkyl;

at each occurrence X⁻ is independently chosen from an anion;

R^{A} is chosen from a substituted or unsubstituted (C₄-C₂₂)alkyl, a substituted or unsubstituted (C₄-C₂₂)alkenyl, and

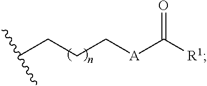

R¹ is chosen from a substituted or unsubstituted (C₄-C₂₂)alkyl and a substituted or unsubstituted (C₄-C₂₂)alkenyl, wherein R¹ is optionally modified, the modification comprising maleic anhydride modification, polymerization, ene-reaction modified, hydrogenation, isomerization, branching, or a combination thereof;

A is —NH— or —O—; and

n is 1 to 10.

Embodiment 7 provides the cationic latex emulsion of any one of Embodiments 1-6, wherein at each occurrence R² is independently chosen from methyl and ethyl.

Embodiment 8 provides the cationic latex emulsion of any one of Embodiments 1-7, wherein at each occurrence R² is methyl.

Embodiment 9 provides the cationic latex emulsion of any one of Embodiments 1-8, wherein at each occurrence R³ is independently chosen from methyl and ethyl.

Embodiment 10 provides the cationic latex emulsion of any one of Embodiments 1-9, wherein R³ is methyl.

Embodiment 11 provides the cationic latex emulsion of any one of Embodiments 1-10, wherein X⁻ is an organic anion.

Embodiment 12 provides the cationic latex emulsion of any one of Embodiments 1-11, wherein X⁻ is an inorganic anion.

Embodiment 13 provides the cationic latex emulsion of any one of Embodiments 1-12, wherein at each occurrence X⁻ is independently chosen from a (C₁-C₁₀)carboxylic acid conjugate base, sulfate, Cl⁻, Br⁻, I⁻, and NO₃⁻.

Embodiment 14 provides the cationic latex emulsion of any one of Embodiments 1-13, wherein R^{A} is independently chosen from a substituted or unsubstituted (C₄-C₂₂)alkyl and a substituted or unsubstituted (C₄-C₂₂)alkenyl.

Embodiment 15 provides the cationic latex emulsion of Embodiment 14, wherein R^{A} is (C₁₀-C₂₀)alkyl.

Embodiment 16 provides the cationic latex emulsion of any one of Embodiments 1-15, wherein R^{A} is

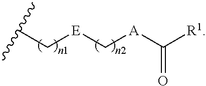

Embodiment 17 provides the cationic latex emulsion of Embodiment 16, wherein R^{A} is

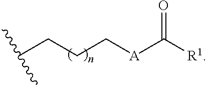

Embodiment 18 provides the cationic latex emulsion of any one of Embodiments 1-17, wherein R¹ is (C₁₀-C₂₀)alkyl.

Embodiment 19 provides the cationic latex emulsion of any one of Embodiments 1-18, wherein R¹ is (C₁₀-C₁₄)alkyl.

Embodiment 20 provides the cationic latex emulsion of any one of Embodiments 1-19, wherein R¹ is C₁₂alkyl.

Embodiment 21 provides the cationic latex emulsion of any one of Embodiments 1-20, wherein R¹ is derived from a bio-based fatty acid source.

Embodiment 22 provides the cationic latex emulsion of any one of Embodiments 1-21, wherein R¹ is derived from a petrochemical fatty acid source.

Embodiment 23 provides the cationic latex emulsion of any one of Embodiments 1-22, wherein R¹ is unmodified.

Embodiment 24 provides the cationic latex emulsion of any one of Embodiments 1-23, wherein R¹ is modified, the modification comprising maleic anhydride modification, ene-reaction modified, hydrogenation, isomerization, polymerization, branching, or a combination thereof.

Embodiment 25 provides the cationic latex emulsion of any one of Embodiments 1-24, wherein A is —NH—.

Embodiment 26 provides the cationic latex emulsion of any one of Embodiments 1-25, wherein A is —O—.

Embodiment 27 provides the cationic latex emulsion of any one of Embodiments 1-26, wherein n1+n2 is 1 to 6.

Embodiment 28 provides the cationic latex emulsion of any one of Embodiments 1-27, wherein n1+n2 is 1 to 3.

Embodiment 29 provides the cationic latex emulsion of any one of Embodiments 1-28, wherein n1+n2 is 1.

Embodiment 30 provides the cationic latex emulsion of any one of Embodiments 1-29, wherein n is 1 to 6.

Embodiment 31 provides the cationic latex emulsion of any one of Embodiments 1-30, wherein n is 1 to 3.

Embodiment 32 provides the cationic latex emulsion of any one of Embodiments 1-31, wherein n is 1.

Embodiment 33 provides the cationic latex emulsion of any one of Embodiments 1-32, wherein the cationic surfactant has the structure:

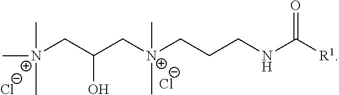

Embodiment 34 provides the cationic latex emulsion of any one of Embodiments 1-33, wherein the cationic surfactant has the structure:

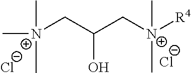

wherein R⁴ is chosen from a substituted or unsubstituted (C₄-C₂₂)alkyl and a substituted or unsubstituted (C₄-C₂₂)alkenyl, wherein R⁴ is optionally modified, the modification comprising maleic anhydride modification, polymerization, ene-reaction modified, hydrogenation, isomerization, branching, or a combination thereof.

Embodiment 35 provides the cationic latex emulsion of any one of Embodiments 1-34, wherein the cationic latex emulsion comprises 0.1% to 20% of the cationic surfactant by weight of the latex particles.

Embodiment 36 provides the cationic latex emulsion of any one of Embodiments 1-35, wherein the cationic latex emulsion comprises 0.5% to 10% of the cationic surfactant by weight of the latex particles.

Embodiment 37 provides the cationic latex emulsion of any one of Embodiments 1-36, wherein the cationic latex emulsion comprises 1% to 5% of the cationic surfactant by weight of the latex particles.

Embodiment 38 provides the cationic latex emulsion of any one of Embodiments 1-37, wherein the cationic latex emulsion comprises 1.5% to 4% of the cationic surfactant by weight of the latex particles.

Embodiment 39 provides the cationic latex emulsion of any one of Embodiments 1-38, wherein the latex particles are 40 wt % to 80 wt % of the cationic latex emulsion.

Embodiment 40 provides the cationic latex emulsion of any one of Embodiments 1-39, wherein the latex particles are 60 wt % to 70 wt % of the cationic latex emulsion.

Embodiment 41 provides the cationic latex emulsion of any one of Embodiments 1-40, wherein the aqueous liquid is 20 wt % to 60 wt % of the cationic latex emulsion.

Embodiment 42 provides the cationic latex emulsion of any one of Embodiments 1-41, wherein the aqueous liquid is 30 wt % to 40 wt % of the cationic latex emulsion.

Embodiment 43 provides the cationic latex emulsion of any one of Embodiments 1-42, wherein the cationic latex emulsion has a viscosity at 25° C. of 1,000 cP to 500,000 cP.

Embodiment 44 provides the cationic latex emulsion of any one of Embodiments 1-43, wherein the cationic latex emulsion has a viscosity at 25° C. of 1,000 cP to 100,000 cP.

Embodiment 45 provides the cationic latex emulsion of any one of Embodiments 1-44, wherein passing the cationic latex emulsion through a 300 micron diameter screen results in less than 0.1 wt % of the cationic latex emulsion remaining on the screen.

Embodiment 46 provides the cationic latex emulsion of any one of Embodiments 1-45, further comprising an acid.

Embodiment 47 provides the cationic latex emulsion of any one of Embodiments 1-46, wherein the acid comprises sulfuric acid, acetic acid, hydrochloric acid, boric acid, phosphoric acid, or a combination thereof.

Embodiment 48 provides a method of forming the cationic latex emulsion of any one of Embodiments 1-47, the method comprising:

combining an anionic latex emulsion with the cationic surfactant, the anionic latex emulsion comprising
the latex particles, and
the aqueous liquid emulsified with the latex particles; and

agitating the combination of the anionic latex emulsion and the cationic surfactant to form the cationic latex emulsion of any one of Embodiments 1-47.

Embodiment 49 provides the method of Embodiment 48, wherein agitating comprises agitating the combination of the anionic latex emulsion and the cationic surfactant to increase the viscosity thereof.

Embodiment 50 provides the method of any one of Embodiments 48-49, wherein agitating comprises agitating the combination of the anionic latex emulsion and the cationic surfactant to increase the viscosity thereof until said viscosity becomes stable.

Embodiment 51 provides the method of any one of Embodiments 48-50, wherein the cationic surfactant is combined with the anionic latex emulsion as a solution of the cationic surfactant in a solvent.

Embodiment 52 provides the method of Embodiment 51, wherein the solvent is an alcohol, a diol, water, or a combination thereof.

Embodiment 53 provides the method of any one of Embodiments 51-52, wherein the solvent comprises a (C₁-C₅)alkyl alcohol, a di(C₁-C₅)alkylene glycol, or a combination thereof.

Embodiment 54 provides the method of any one of Embodiments 51-53, wherein the solvent comprises ethanol, methanol, diethylene glycol, dipropylene glycol, isopropyl alcohol, water, or a combination thereof.

Embodiment 55 provides the method of any one of Embodiments 51-54, wherein the solvent comprises water.

Embodiment 56 provides the method of any one of Embodiments 51-55, wherein the solvent comprises a mixture of water with ethanol, diethylene glycol, or a combination there.

Embodiment 57 provides the method of any one of Embodiments 51-56, wherein the cationic surfactant is about 20 wt % to 80 wt % of the solution of the cationic surfactant in the solvent.

Embodiment 58 provides the method of any one of Embodiments 51-57, wherein the cationic surfactant is about 45 wt % to 60 wt % of the solution of the cationic surfactant in the solvent.

Embodiment 59 provides the method of any one of Embodiments 51-58, further comprising:

reacting HOC(O)—R¹ with a compound having the structure

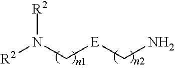

to provide a terminal amine having the structure

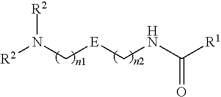

acidifying the terminal amine to provide an ammonium salt;

treating the ammonium salt with an epihalohydrin to provide a gamma hydroxy haloammonium salt; and

treating the gamma hydroxy haloammonium salt with (R³)₃N, to provide the cationic surfactant.

Embodiment 60 provides the method of any one of Embodiments 51-59, further comprising:

reacting HOC(O)—R¹ with a compound having the structure

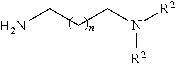

to provide a terminal amine having the structure

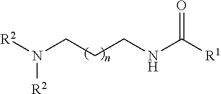

acidifying the terminal amine to provide an ammonium salt;
treating the ammonium salt with an epihalohydrin to provide a gamma hydroxy haloammonium salt; and

treating the gamma hydroxy haloammonium salt with (R³)₃N, to provide the cationic surfactant.

Embodiment 61 provides the method of any one of Embodiments 51-60, further comprising:

acidifying an amine having the structure

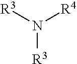

wherein R⁴ is chosen from a substituted or unsubstituted (C₄-C₂₂)alkyl and a substituted or unsubstituted (C₄-C₂₂)alkenyl, wherein R⁴ is optionally modified, the modification comprising maleic anhydride modification, polymerization, ene-reaction modified, hydrogenation, isomerization, branching, or a combination thereof.

to provide an ammonium salt;

treating the ammonium salt with an epihalohydrin to provide a gamma hydroxy haloammonium salt; and

treating the gamma hydroxy haloammonium salt with (R³)₃N, to provide the cationic surfactant.

Embodiment 62 provides an asphalt emulsion comprising the cationic latex emulsion of any one of Embodiments 1-47.

Embodiment 63 provides the asphalt emulsion of Embodiment 62, wherein the asphalt emulsion comprises bitumen, an aqueous liquid, and the cationic latex emulsion of any one of Embodiments 1-47.

Embodiment 64 provides the asphalt emulsion of any one of Embodiments 62-63, wherein bitumen is 1 wt % to 99 wt % of the asphalt emulsion.

Embodiment 65 provides the asphalt emulsion of any one of Embodiments 62-64, wherein bitumen is 50 wt % to 75 wt % of the asphalt emulsion.

Embodiment 66 provides the asphalt emulsion of any one of Embodiments 62-65, wherein aqueous liquid is 0.1 wt % to 50 wt % of the asphalt emulsion.

Embodiment 67 provides the asphalt emulsion of any one of Embodiments 62-66, wherein aqueous liquid is 1 wt % to 40 wt % of the asphalt emulsion.

Embodiment 68 provides the asphalt emulsion of any one of Embodiments 62-67, wherein the cationic surfactant is 0.001 wt % to 50 wt % of the asphalt emulsion.

Embodiment 69 provides the asphalt emulsion of any one of Embodiments 62-68, wherein the cationic surfactant is 0.01 wt % to 20 wt % of the asphalt emulsion.

Embodiment 70 provides the asphalt emulsion of any one of Embodiments 62-69, wherein the cationic latex emulsion is 0.01 wt % to 90 wt % of the asphalt emulsion.

Embodiment 71 provides the asphalt emulsion of any one of Embodiments 62-70, wherein the cationic latex emulsion is 0.1 wt % to 50 wt % of the asphalt emulsion.

Embodiment 72 provides the asphalt emulsion of any one of Embodiments 62-71, wherein the asphalt emulsion is a cationic asphalt emulsion comprising cationic bitumen particles.

Embodiment 73 provides an asphalt emulsion comprising:

the cationic latex emulsion of any one of Embodiments 1-47; and

cationic bitumen particles.

Embodiment 74 provides a method of forming the asphalt emulsion of any one of Embodiments 62-72, the method comprising:

combining a cationic asphalt emulsion with the cationic latex emulsion of any one of Embodiments 1-47, to form the asphalt emulsion of any one of Embodiments 62-72.

Embodiment 75 provides a method of coating a carpet to form a carpet back coating, the method comprising:

coating the carpet with the cationic latex emulsion of any one of Embodiments 1-47 to form the carpet back coating thereon.

Embodiment 76 provides a paper coating, tires, asphalt concrete, carpet back coating, latex paint, foam, or ink comprising:

the cationic latex emulsion of any one of Embodiments 1-47.

Embodiment 77 provides the cationic latex emulsion, method of forming the cationic latex emulsion, asphalt emulsion, method of forming the asphalt emulsion, method of coating a carpet, or paper coating, tires, asphalt concrete, carpet back coating, latex paint, foam, or ink of any one or any combination of Embodiments 1-76 optionally configured such that all elements or options recited are available to use or select from.

1. A cationic latex emulsion comprising:
latex particles;
an aqueous liquid emulsified with the latex particles; and
a cationic surfactant having the structure: 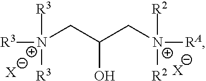
wherein
at each occurrence R² is independently chosen from substituted or unsubstituted linear or branched (C₁-C₆)alkyl, substituted or unsubstituted linear or branched (C₁-C₆)alkenyl, substituted or unsubstituted (C₄-C₁₀)cycloalkyl or (C₄-C₁₀)cycloalkenyl, substituted or substituted or unsubstituted (C₁-C₁₀)alkoxy (for example (C₁-C₁₀)alkyl alcohol, (C₁-C₁₀)alkyl ether or (C₁-C₁₀)alkoxyalcohol), and substituted or unsubstituted (C₄-C₁₀)aryl, or wherein R² together with another R² forms a substituted or unsubstituted aliphatic or aromatic (C₄-C₁₂)heterocycle together with the nitrogen to which they are attached;
at each occurrence R³ is independently chosen from substituted or unsubstituted linear or branched (C₁-C₆)alkyl, substituted or unsubstituted linear or branched (C₁-C₆)alkenyl, substituted or unsubstituted (C₄-C₁₀)cycloalkyl or (C₄-C₁₀)cycloalkenyl, substituted or unsubstituted (C₁-C₁₀)alkoxy (for example, (C₁-C₁₀)alkyl alcohol, (C₁-C₁₀)alkyl ether or (C₁-C₁₀)alkoxyalcohol), and substituted or unsubstituted (C₄-C₁₀)aryl, or wherein R³ together with another R³ forms a substituted or unsubstituted aliphatic or aromatic (C₄-C₁₂)heterocycle together with the nitrogen to which they are attached;
at each occurrence X⁻ is independently chosen from an anion;
R^{A} is chosen from a substituted or unsubstituted (C₄-C₂₂)alkyl, a substituted or unsubstituted (C₄-C₂₂)alkenyl, and 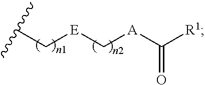
R¹ is chosen from a substituted or unsubstituted (C₄-C₂₂)alkyl and a substituted or unsubstituted (C₄-C₂₂)alkenyl, wherein R¹ is optionally modified, the modification comprising maleic anhydride modification, polymerization, ene-reaction modified, hydrogenation, isomerization, branching, or a combination thereof;
A is —NH— or —O—;
E is —CH₂—, —((C₂-C₄)alkoxy)ₙ₃-, or —O—;
n1 is an integer that is 0 to 9, for example 1;
n2 is an integer that is 0 to 9, for example 1;
n1+n2 is 1 to 10; and
n3 is an integer that is 1 to 40.

2. The cationic latex emulsion of claim 1, wherein:
at each occurrence R² is independently chosen from substituted or unsubstituted (C₁-C₆)alkyl;
at each occurrence R³ is independently chosen from substituted or unsubstituted (C₁-C₆)alkyl;
at each occurrence X⁻ is independently chosen from an anion;
R^{A} is chosen from a substituted or unsubstituted (C₄-C₂₂)alkyl, a substituted or unsubstituted (C₄-C₂₂)alkenyl, and 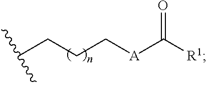
R¹ is chosen from a substituted or unsubstituted (C₄-C₂₂)alkyl and a substituted or unsubstituted (C₄-C₂₂)alkenyl, wherein R¹ is optionally modified, the modification comprising maleic anhydride modification, polymerization, ene-reaction modified, hydrogenation, isomerization, branching, or a combination thereof;
A is —NH— or —O—; and
n is 1 to 10, for example 1.

3. The cationic latex emulsion of claim 1, wherein R¹ is derived from a bio-based fatty acid source.

4. The cationic latex emulsion of claim 1, wherein R¹ is unmodified.

5. The cationic latex emulsion of claim 1, wherein R¹ is modified, the modification comprising maleic anhydride modification, ene-reaction modified, hydrogenation, isomerization, polymerization, branching, or a combination thereof.

6. The cationic latex emulsion of claim 1, wherein the cationic surfactant has the structure:

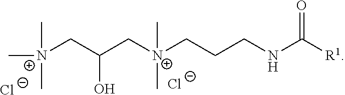

7. The cationic latex emulsion of claim 1, wherein the cationic surfactant has the structure: 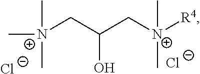
wherein R⁴ is chosen from a substituted or unsubstituted (C₄-C₂₂)alkyl and a substituted or unsubstituted (C₄-C₂₂)alkenyl, wherein R⁴ is optionally modified, the modification comprising maleic anhydride modification, polymerization, ene-reaction modified, hydrogenation, isomerization, branching, or a combination thereof.

8. The cationic latex emulsion of claim 1, wherein the cationic latex emulsion comprises 0.1% to 20% of the cationic surfactant by weight of the latex particles.

9. A method of forming the cationic latex emulsion of claim 1, the method comprising:
combining an anionic latex emulsion with the cationic surfactant, the anionic latex emulsion comprising
the latex particles, and
the aqueous liquid emulsified with the latex particles; and
agitating the combination of the anionic latex emulsion and the cationic surfactant to form the cationic latex emulsion of claim 1.

10. The method of claim 9, wherein agitating comprises agitating the combination of the anionic latex emulsion and the cationic surfactant to increase the viscosity thereof until said viscosity becomes stable.

11. The method of claim 9, wherein the cationic surfactant is combined with the anionic latex emulsion as a solution of the cationic surfactant in a solvent.

12. The method of claim 11, further comprising:
reacting HOC(O)—R¹ with a compound having the structure 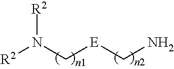
to provide a terminal amine having the structure 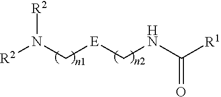
acidifying the terminal amine to provide an ammonium salt;
treating the ammonium salt with an epihalohydrin to provide a gamma hydroxy haloammonium salt; and
treating the gamma hydroxy haloammonium salt with (R³)₃N, to provide the cationic surfactant.

13. The method of claim 11, further comprising:
reacting HOC(O)—R¹ with a compound having the structure 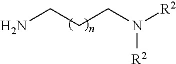
to provide a terminal amine having the structure 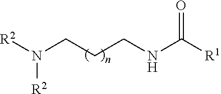
acidifying the terminal amine to provide an ammonium salt;
treating the ammonium salt with an epihalohydrin to provide a gamma hydroxy haloammonium salt; and
treating the gamma hydroxy haloammonium salt with (R³)₃N having the structure to provide the cationic surfactant.

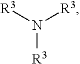

14. The method of claim 11, further comprising:
acidifying an amine having the structure 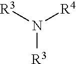
wherein R⁴ is chosen from a substituted or unsubstituted (C₄-C₂₂)alkyl and a substituted or unsubstituted (C₄-C₂₂)alkenyl, wherein R⁴ is optionally modified, the modification comprising maleic anhydride modification, polymerization, ene-reaction modified, hydrogenation, isomerization, branching, or a combination thereof.
to provide an ammonium salt;
treating the ammonium salt with an epihalohydrin to provide a gamma hydroxy haloammonium salt; and
treating the gamma hydroxy haloammonium salt with (R³)₃N, to provide the cationic surfactant.

15. The method of claim 9, wherein the method further includes treating the cationic latex emulsion with an acid to reduce the viscosity of the cationic latex emulsion.

16. The method of claim 13 wherein R³ is chosen from substituted or unsubstituted linear or branched (C₁-C₆)alkyl, substituted or unsubstituted linear or branched (C₁-C₆)alkenyl, and substituted or unsubstituted (C₁-C₆)alkyl alcohol.

17. An asphalt emulsion comprising the cationic latex emulsion of claim 1.

18. The asphalt emulsion of claim 17, wherein the asphalt emulsion comprises bitumen, an aqueous liquid, and the cationic latex emulsion of claim 1.

19. An asphalt emulsion comprising:
the cationic latex emulsion of claim 1; and
cationic bitumen particles.

20. A method of forming the asphalt emulsion of claim 17, the method comprising:
combining a cationic asphalt emulsion with the cationic latex emulsion, to form the asphalt emulsion of claim 17.

21. (canceled)

22. (canceled)
